(19) United States
(12) Patent Application Publication
(10) Pub. No.: US 2026/0275676 A1
(43) Pub. Date: Sep. 17, 2026

(54) WALL ELEMENT FOR A SIDEWALL OF A MANHOLE

(71) Applicant: LANGMATZ GmbH, Garmisch-Partenkirchen (DE)

(72) Inventors: Matthias THUMM, Mittenwald (DE); Stefan Jais, Mittenwald (DE)

(21) Appl. No.: 19/567,867

(22) Filed: Mar. 16, 2026

(30) Foreign Application Priority Data
Mar. 17, 2025 (DE) 102025110144.2

(51) Int. Cl. E02D 29/12

(52) U.S. Cl. CPC E02D 29/121

(57) ABSTRACT

A wall element for a side wall of a manhole, in particular a cable manhole, has complementary components of module latching parts arranged at opposite edges.

### FIELD OF DISCLOSURE

The present disclosure generally relates to manholes which are installed in the ground as part of the public infrastructure. In particular, the present disclosure relates to modular manholes in which different lines-such as power cables, fiber optic cables, or district heating pipes-can be connected, routed, or brought together.

### BACKGROUND

Such manholes are used in networks for power supply, electronic control systems, telecommunications, and also energy supply. They consist of a plastic base body, a frame placed on top of the base body, and a manhole cover. When the manhole cover is removed, the interior of the manhole is accessible, allowing lines to be connected, branches to be installed, or other work to be carried out on the lines there. Such manholes can also be used as underground distributors or as foundations for charging stations or similar.

The manhole is usually buried in the soil such that the manhole cover is flush with the ground level. Depending on the operating site, the manhole cover must not only prevent unauthorized access to the interior of the manhole, but also absorb traffic loads, for example, if the manhole is installed in a location where it is driven over by vehicles. In addition to horizontal loads resulting from the earth pressure acting thereon, the side walls of the manhole must also absorb vertical loads resulting from vehicles and dissipate them downwards.

In construction and infrastructure projects, the challenge regularly arises that the manhole must be adapted to different conditions, i.e., different types of lines, different numbers of lines, and different positions of lines already laid where the manhole is to be installed. Manholes are often ordered with specific configurations according to the respective conditions, or a construction company or building authority must have a large number of differently configured manholes in stock to be able to react flexibly at short notice if a manhole needs to be replaced or the conditions on site are different than expected.

In addition, installation in already existing infrastructure poses the problem that lines must be fed into the manhole from the side. This often requires that appropriate passages be prepared in the manhole wall in advance. Retrofitting such passages may be complex and expensive, depending on the manhole design. If subsequent machining is required, this leads to noise pollution. In addition, dust that is hazardous to health is released. It may also be necessary to expose or even relocate existing lines if the manhole does not have a function for “overbuilding” existing lines.

In view of above, there remains a need to create a manhole which can be flexibly adapted to the respective requirements.

### SUMMARY

In an example embodiment, wall elements can be assembled to form modules using a latching connection. This can be done on site without tools and with little effort. Furthermore, the advantage is achieved that the wall elements can be transported stacked flat, resulting in a low transport volume.

Specifically, a wall element for a side wall of a manhole is provided according to the invention, in particular a cable manhole, wherein complementary components of module latching parts are arranged at opposite edges. The wall parts can be plugged together by the module latching parts, so that a module composed of (usually) four wall elements is obtained, which is inherently stable. A plurality of modules can be plugged together vertically to form a manhole of the desired height. The manhole can be assembled without tools and, if necessary, can preferably also be dismantled without tools.

According to one embodiment, it is provided that the module latching parts are formed by at least one plug-in nose on one edge of the wall element and at least one plug-in receptacle on the opposite edge. This type of connection is characterized by a high degree of stability.

Preferably, the plug-in nose has a thickness decreasing towards the free end. This makes it easier to insert the plug-in nose into the plug-in receptacle, as the decreasing thickness acts similarly to an insertion bevel.

According to a preferred configuration, the plug-in nose has a curved outer surface. This makes it easier to guide the last wall element of a module into its final position.

Preferably, a snap-in element is provided in the plug-in receptacle, which can cooperate with an abutment on the plug-in nose of a second wall element. The snap-in element automatically locks the wall element as soon as it is fully inserted into the plug-in receptacle with the plug-in nose.

An engagement recess may be provided on the plug-in receptacle and on the plug-in nose so that the snap-in element can be moved by hand from a locking position to a release position. No tools are then required to detach the wall elements from each other, should this become necessary.

According to one embodiment, it is provided that the module latching parts have at least two connecting blocks at a first end in a first and a third position and have at least two connecting blocks at the second end in a second and a fourth position, wherein at least two receiving openings are provided at the first end at a second and a fourth position and at least two receiving openings are provided at the second end at a first and a third position. The connecting blocks can be used to connect two wall elements in a particularly stable manner with regard to vertical loads acting in the vertical direction between two wall elements.

Preferably, it is provided that at least one snap-in element is provided at each end, which can cooperate with an abutment at the associated end of another wall element. In this way, two wall elements can be locked together without tools when they are fully plugged together.

Preferably, the abutment has a groove which can serve as a guide for an unlocking tool. This makes it easier for an installer to position the tool correctly.

According to one configuration, two snap-in elements are provided so that the corner connection is particularly stable.

Preferably, an insertion bevel is provided on the connecting blocks and/or the receiving openings, which facilitates the joining of the wall elements in the corner sections.

A guiding projection may be provided, which cooperates with the insertion bevel when the corners are connected to each other, wherein the insertion bevel is located outside the guiding projection in the fully assembled state. This makes it possible to join the wall elements in one direction and to dismantle them again in a direction perpendicular thereto.

The present disclosure also relates to a module for a manhole, wherein the module is composed of four interconnected wall elements, the fourth of which is adapted to be connected to two other wall elements to form a closed module by a combined plugging and rotary movement. With regard to the resulting advantages, reference is made to the above explanations. In particular, it is advantageous that the wall elements can be detached from each other without tools.

Furthermore, the present disclosure relates to a module for a manhole, wherein the module is composed of four interconnected wall elements, the fourth of which is adapted be connected to two other wall elements to form a closed module by a purely translational movement. Here, too, reference is made to the above explanations with regard to the resulting advantages. No tools are required to assemble the wall parts, while a very simple plug-in tool is sufficient for disassembly.

### BRIEF DESCRIPTION OF THE DRAWINGS

The present disclosure is described below with reference to various embodiments, which are illustrated in the accompanying drawings in which:

FIG. 1 shows a manhole according to a first embodiment in a perspective view,

FIG. 2 shows the manhole of FIG. 1 in a first side view,

FIG. 3 shows the manhole of FIG. 1 in a second side view,

FIG. 4 shows a manhole according to a second embodiment in a perspective view,

FIG. 5 shows a module for the manhole of the first embodiment in a perspective view,

FIG. 6 shows the module of FIG. 5 in a partially assembled state,

FIG. 7 shows a corner section of the module of FIG. 5 in an enlarged perspective view,

FIG. 8 shows the corner section of FIG. 7 cut horizontally,

FIG. 9 shows a wall element of the module of FIG. 5 in a perspective view,

FIG. 10 shows the wall element of FIG. 9 in a first side view, wherein the wall element has been machined,

FIG. 11 shows a detailed view of the end of the wall element on the right in FIG. 10,

FIG. 12 shows the detail of FIG. 11 in a perspective view,

FIG. 13 shows the wall element of FIG. 9 in a second side view,

FIG. 14 shows a detailed view of the end of the wall element on the left in FIG. 13,

FIG. 15 shows a detailed perspective view of the end of the wall element on the right in FIG. 13,

FIG. 16 shows a view corresponding to that of FIG. 7 of a corner section of a module according to a second variant embodiment,

FIG. 17 shows the corner section of FIG. 16 in a horizontal section,

FIG. 18 shows the corner section of FIG. 16 in a partially assembled state,

FIG. 19 shows the corner section of FIG. 16 viewed from inside the module,

FIG. 20 shows a view corresponding to that of FIG. 7 of a corner section of a module according to a third variant embodiment,

FIG. 21 shows the corner section of FIG. 20 in a partially assembled state viewed from inside the module,

FIG. 22 shows the corner section of FIG. 20 in a partially assembled state as viewed from outside the module,

FIG. 23 shows a detailed view of the end of the wall element on the right in FIG. 22,

FIG. 24 shows a section along plane XXIV-XXIV of FIG. 21,

FIG. 25 shows a horizontally sectioned detailed view of the end of the wall element shown in FIG. 23,

FIG. 26 shows a partially sectioned view from the inside of two modules of the manhole according to the first embodiment, fastened together in a first configuration,

FIG. 27 shows the detail XXVII of FIG. 26,

FIG. 28 shows a section along plane XXXVIII of FIG. 2,

FIG. 29 shows a section of FIG. 28 on an enlarged scale,

FIG. 30 shows a section along plane XXX of FIG. 2,

FIG. 31 shows a perspective view of two modules of the manhole according to the first embodiment, fastened together in a second configuration,

FIG. 32 shows a corner of the modules of FIG. 31 viewed from inside the modules,

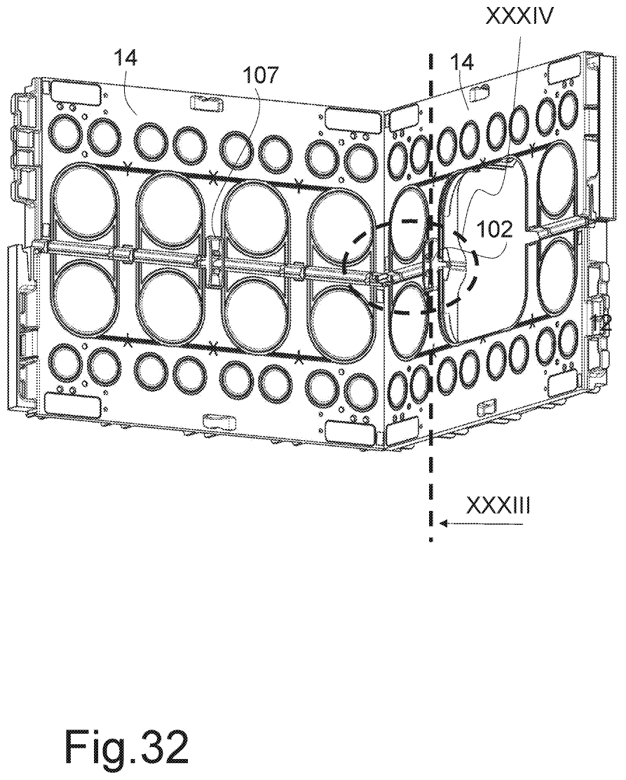

FIG. 33 shows a section along plane XXXII of FIG. 32,

FIG. 34 shows an enlarged view of detail XXXIV of FIG. 32,

FIG. 35 shows a perspective view of a connector part used to connect two modules in the second configuration,

FIG. 36 shows the connector part of FIG. 35 in a front view,

FIG. 37 shows the connector part of FIG. 35 in a perspective sectional view,

FIG. 38 shows a detail of an outer edge of the wall element of the first embodiment,

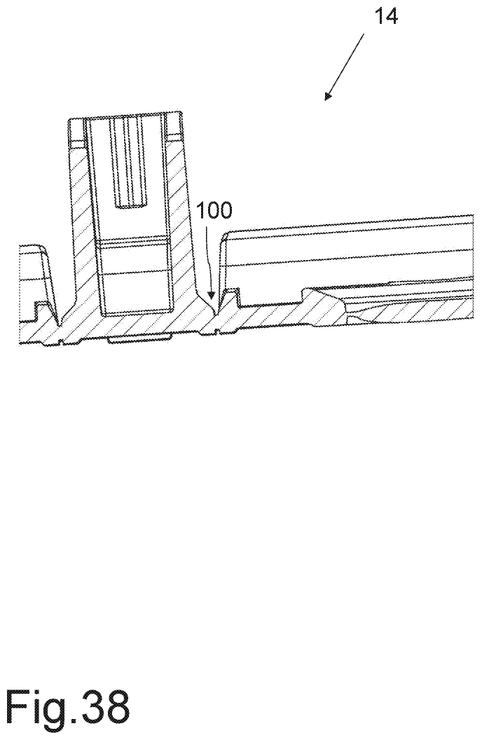

FIG. 39 shows the detail of FIG. 38 in a perspective view,

FIG. 40 shows a wall element for a manhole according to a third embodiment in a side view,

FIG. 41 shows the wall element of FIG. 40 in a different configuration,

FIG. 42 shows the wall element of FIG. 40 in another configuration in a perspective side view from the inside,

FIG. 43 shows a perspective view of the frame of the manhole of FIG. 1,

FIG. 44 shows a detailed view of the corner section of the frame of FIG. 43,

FIG. 45 shows a perspective view of a segment of the frame of Figure in a section along plane XLV,

FIG. 46 shows a perspective view of the segment of FIG. 45 in a section along plane XLVI,

FIG. 47 shows an adapter plug for the manhole in a top view in a closed state,

FIG. 48 shows the adapter plug of FIG. 47 in a bottom view,

FIG. 49 shows the adapter plug of FIG. 47 in a side view,

FIG. 50 shows the adapter plug of FIG. 47 in a perspective view,

FIG. 51 shows the adapter plug of FIG. 47 in an assembly position in a top view,

FIG. 52 shows the adapter plug of FIG. 51 in a side view,

FIG. 53 shows the adapter plug of FIG. 51 in a first perspective view,

FIG. 54 shows the adapter plug of FIG. 51 in a second perspective view, and

FIG. 55 shows an adapter plug in a variant embodiment.

### DETAILED DESCRIPTION

The present disclosure relates to modular manholes in which different lines such as power cables, fiber optic cables, or district heating pipes-can be connected, routed, or brought together. Where reference is made to lines below, this is to be understood as a generic term for all lines, cables, pipes, etc. that are laid in the soil and to which the manhole provides access.

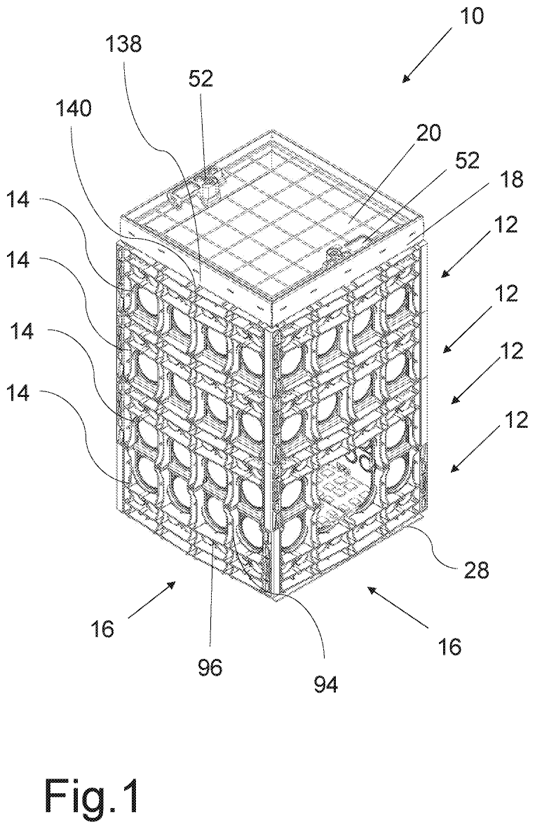

FIGS. 1 to 3 show a manhole 10 according to a first embodiment. The manhole 10 is designed to be buried in the ground so as to be flush with the ground level.

The manhole 10 has a plurality of modules 12, which are rectangular in a top view. In the first embodiment, they are square. Each module 12 in turn has four wall elements 14, which are connected at their ends to the respectively adjacent wall element 14.

The modules 12 are arranged one above the other and connected to each other. The height of the manhole 10 can be flexibly adapted to the respective requirements by the number of modules 12 which are connected to each other.

In the example embodiment shown, four modules 12 are used. Depending on the requirements and installation situation, the manhole may also have a smaller number of modules (down to a single module) or more than four modules.

Wall elements 14 arranged one above the other form a side wall 16 of the manhole 10.

The wall elements 14 are made of plastic. They are injection molded. All wall elements 14 are designed so that they can be manufactured in injection molding tools without the need for slides.

A frame 18 made of steel is arranged on the uppermost one of the modules 12. The frame 18 serves to accommodate a manhole cover 20, which closes off access to the interior of the manhole 10.

The manhole cover 20 can be locked onto the frame 18 so that it cannot be removed by unauthorized persons and there is no risk of it being lifted out of the frame 18 by vibrations or air suction when driven over.

A plurality of different passage openings 22, 23 each of which is closed by a cover 24 in the initial state is provided in each wall element 14.

The wall elements 14 that make up the modules 12 are generally rectangular in a side view and have two long edges and two short edges. For simplicity, the longer edge, which is at the top in most configurations when installed, is referred to as the upper edge 25. The edge parallel thereto is referred to as the lower edge 26. The short edges therebetween are referred to as side edges 27.

Also for simplicity, the side of the wall elements 14 which is on the outside in the installed state of the manhole 10 is referred to as the outside of the wall elements 14. Accordingly, the inside of the wall elements 14 is the side which faces the opposite wall element 14 in the installed state of the manhole 10.

Where terms such as “top,” “bottom,” or “vertical” are used below, reference is made to the normal installation position of the manhole 10, in which the manhole cover 20 is at the top and aligned horizontally.

In the configuration shown in FIGS. 1 to 3, the manhole 10 consists of four modules 12. The frame 18 is placed on the upper edge 25 of the four wall elements 14 of the uppermost module 12. The lower edge 26 of the wall elements 14 of the first and the second module 12 is placed on the upper edge 25 of the wall elements 14 of the second and the third module 12.

The lower edge 26 of the wall elements 14 of the third module 12 is attached here to the lower edge 26 of the wall elements 14 of the fourth module 12. The fourth module 12 is therefore mounted “upside down.” This allows a rectangular passage opening 21 to be created or the position of passages to be shifted.

A base plate 28 is attached to the side of the wall elements 14 of the fourth module 12 facing away from the frame 18.

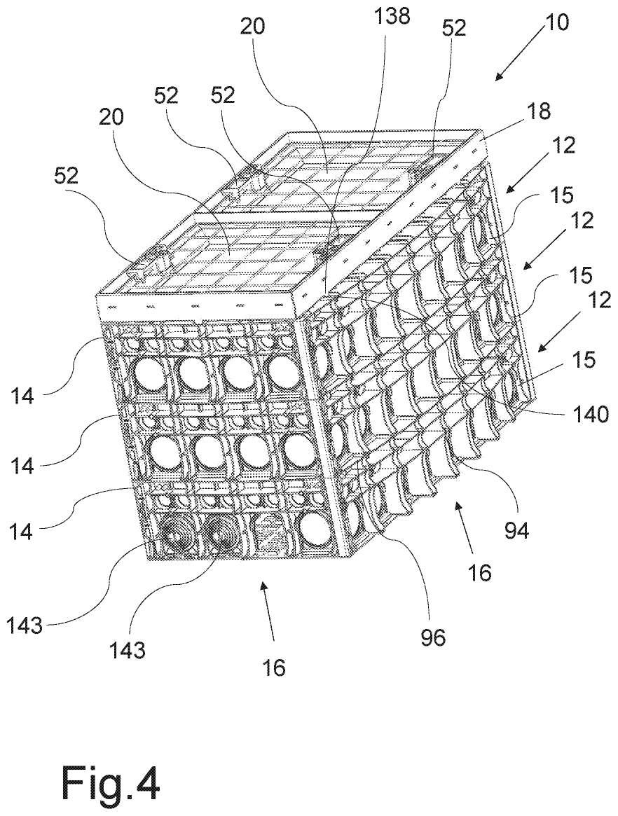

FIG. 4 shows a second embodiment. The same reference numerals are used for the components and features known from the first embodiment, reference being made to the above explanations in this respect.

The difference between the first and the second embodiment is that, in the second embodiment, the manhole 10, viewed in a horizontal section, is not square as in the first embodiment, but rectangular with two longer wall elements 15 and two shorter wall elements 14.

In contrast to the first embodiment, the manhole 10 in the second embodiment also consists of only three interconnected modules 12. However, it is also possible to use a different number of modules here.

A further difference is that two square manhole covers 20 are accommodated next to each other in the frame 18.

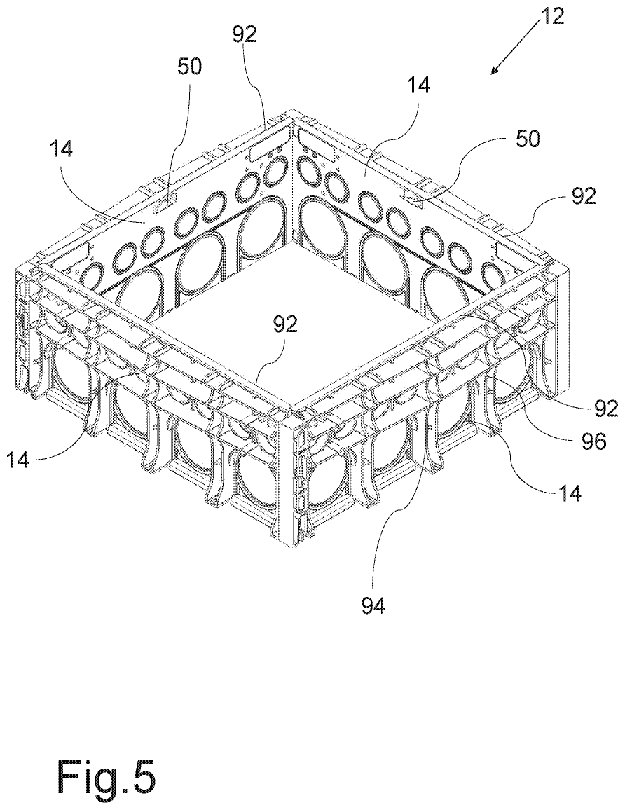

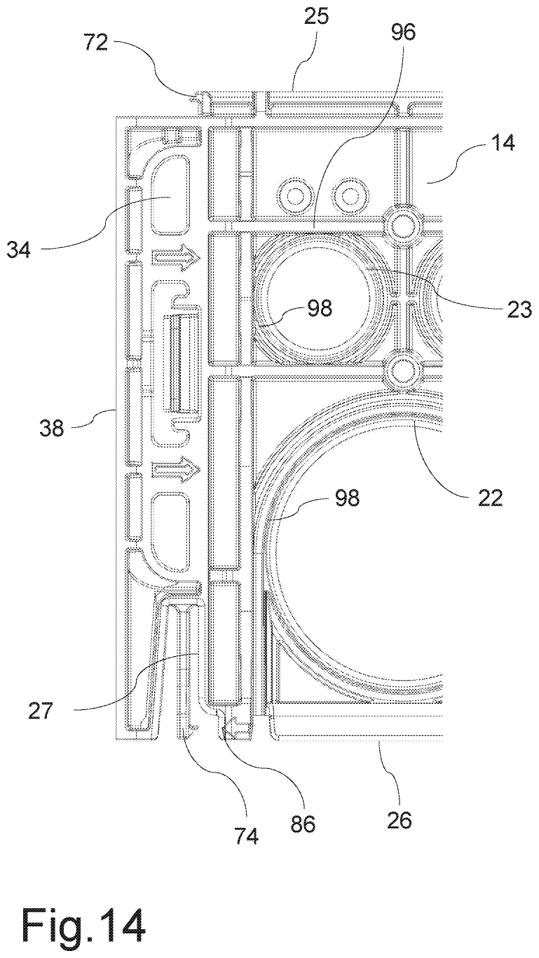

The modules 12 and the wall elements 14 that make up the manhole 10 of the first embodiment are described below with reference to FIGS. 5 to 15.

The wall elements 14 forming a module 12 are connected to each other at their short edges at an angle of 90°. Assembly is tool-free. The connection formed can also be disconnected without tools.

In the first embodiment, each wall element 14 has a component of mutually complementary module latching parts on one side edge.

In the first embodiment, these module latching parts are formed by a plug-in nose 32 on one side edge and a plug-in receptacle 34 on the other side edge.

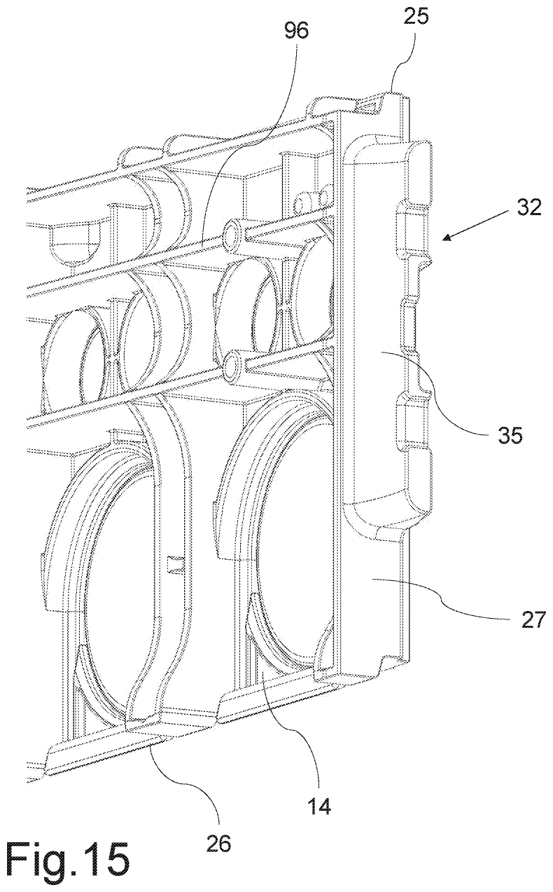

The plug-in nose 32 (see in particular FIG. 15) has a continuous outer surface 35 on the outside which is concave to a vertical axis. On the inside, the plug-in nose 32 is provided with reinforcing ribs 36.

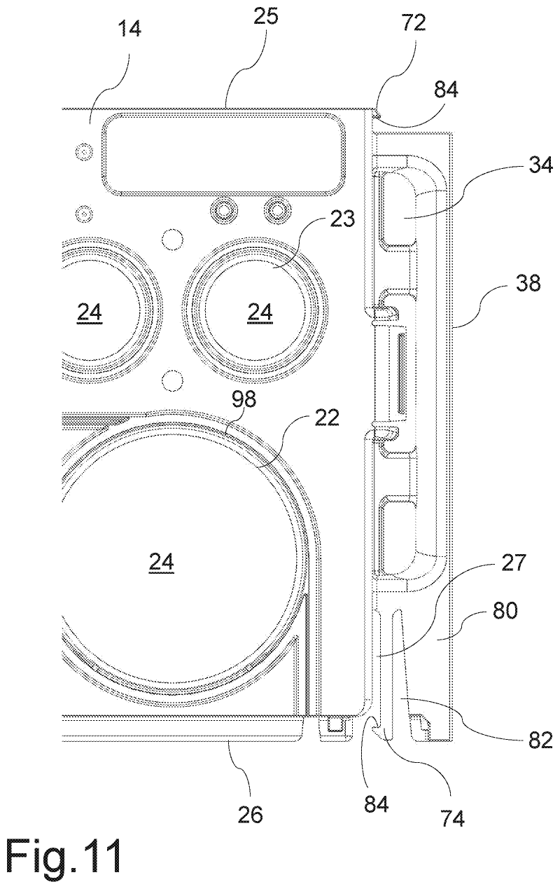

The plug-in receptacle 34 (see in particular FIGS. 11, 12, and 14) is provided with an external bracket 38 which surrounds the space into which the plug-in nose 32 of another wall element 14 can be inserted.

The bracket 38 has a curved inner surface 39 on its long section, which is complementary to the curved outer surface 35 of the plug-in noses 32.

On the outside of the wall element 14, the bracket 38 is connected to the inside of the wall element 14 by two webs 40. This creates three passage openings 41, with which projections 42 on the plug-in nose 32 are associated.

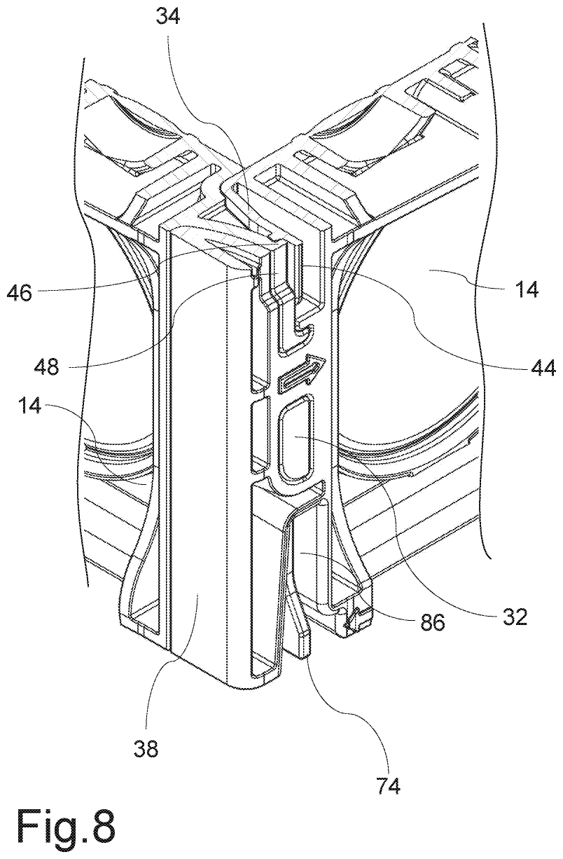

Within the space defined by the bracket 38, a snap-in element 44 is provided which, when wall elements 14 are connected to each other to form a module 12, can cooperate with an abutment 46 provided on the inside of the plug-in nose 32 (see in particular FIG. 8).

Both in the bracket 38 of the plug-in receptacle 34 and in the end face of the plug-in nose 32, an engagement recess 48 is provided, which allows an operator to move the snap-in element 44 from a locking position, which can be seen in FIG. 8, to a release position (in the direction of an arrow placed on the wall element 14), in which the abutment 46 is released and the plug-in nose 32 can be pulled out of the plug-in receptacle 34.

To assemble a module 12, the plug-in nose 32 of one wall element 14 is inserted into the plug-in receptacle 34 of a second wall element 14 until the snap-in element 44 engages behind the abutment 46. This is also possible with the fourth wall element 14. This is inserted with its curved outer surface 35 at a slight angle with its plug-in nose 32 into the plug-in receptacle 34 of the already mounted wall elements 14 until it latches there, and is then pushed with its plug-in receptacle 34 onto the plug-in nose 32 of the already mounted, adjacent wall element 14 in a rotary movement about an axis defined by the curved outer surface 35 of the plug-in nose 32. As soon as the snap-in element 44 latches behind the abutment 46, the module 12 is complete.

If the module 12 is to be dismantled again, one snap-in element 44 after the other is moved into the release position and the corresponding plug-in nose 32 is pulled out of the plug-in receptacle 34.

Each wall element 14 has a locking opening 50 near the upper edge 25 on the inside, approximately in the center, into which a bolt can engage, which is part of a locking mechanism 52 mounted in the manhole cover 20. The locking opening 50 can be used when a particularly flat frame is arranged on the uppermost module 12.

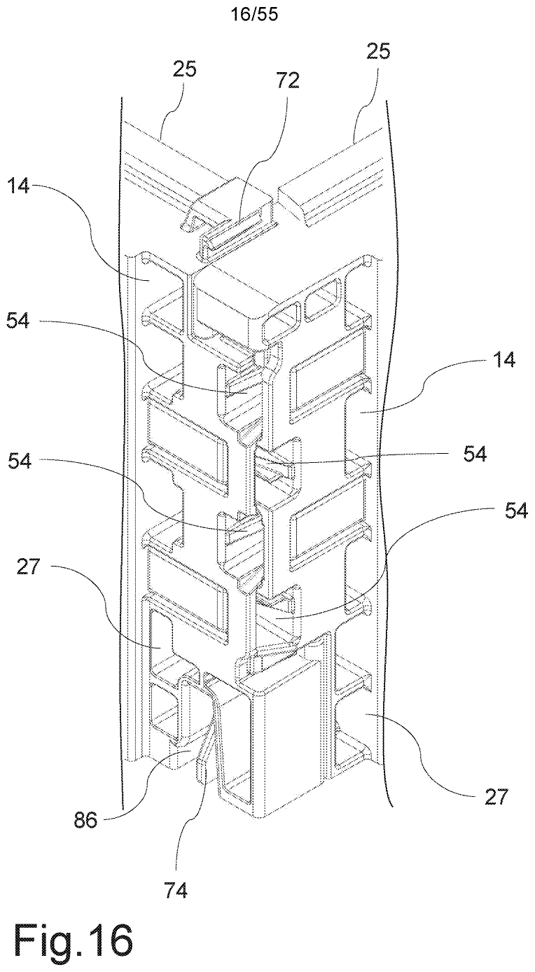

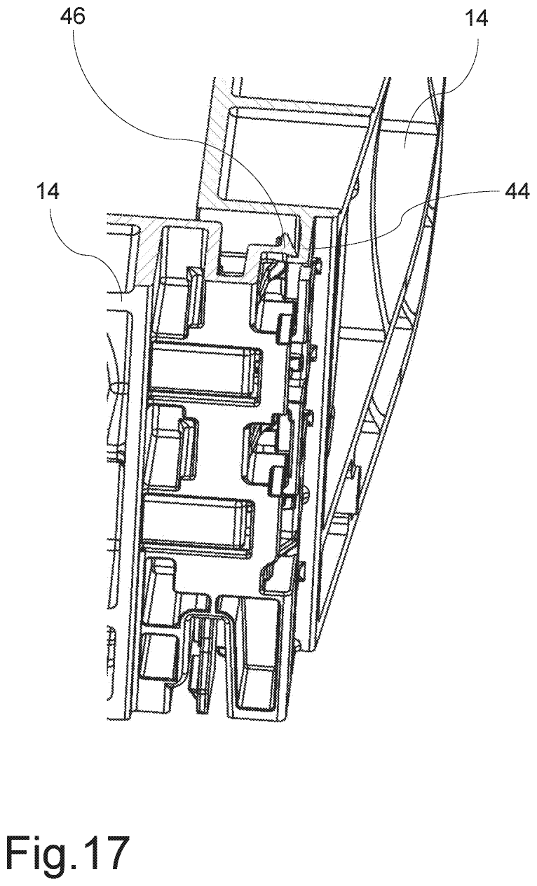

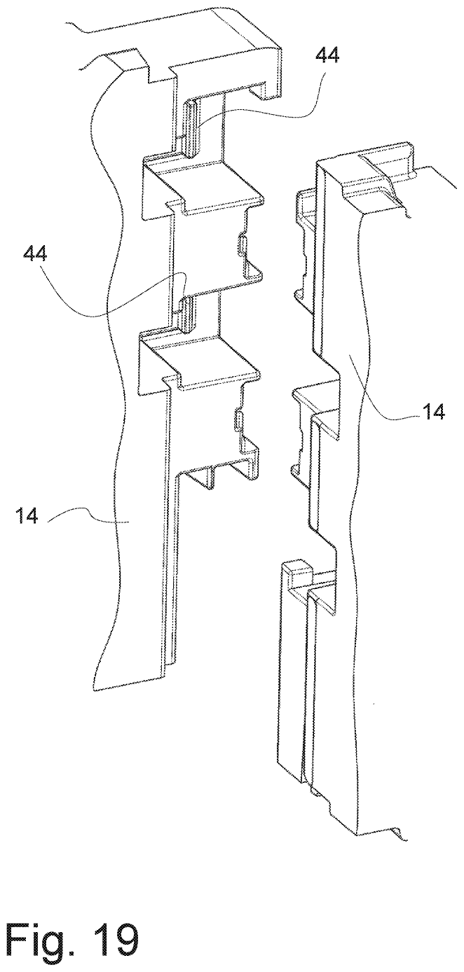

A second variant embodiment of a corner connection for the wall elements 14 is described below with reference to FIGS. 16 to 19. The same reference numerals are used for the components and features known from the first variant embodiment of FIGS. 5 to 16, reference being made to the above explanations in this respect.

The difference between the first and the second variant embodiment is that in the second variant embodiment, the wall elements 14 can be connected to each other with a purely translational movement.

In the second variant embodiment, the complementary module latching parts are formed from a plurality of connecting blocks 54 that interlock like a comb. Receiving openings 56 for the connecting blocks 54 of the other wall element 14 are provided correspondingly between the connecting blocks 54 of one wall element 14.

The connecting blocks 54 are designed such that each wall element 14 can be attached to the other wall elements 14 in an exclusively translational movement. This is particularly important when installing the fourth wall element 14 of a module 12, as a purely translational movement can be easily automated.

Each receiving opening 56 is assigned a snap-in element 44 which can cooperate with an abutment 46 on the connecting block 54 of another wall element 14.

The abutments 46 are provided here with a central groove 47, which serves as a guide for an unlocking tool. The unlocking tool can be inserted from the outside and simultaneously move both snap-in elements 44 outwards into a release position.

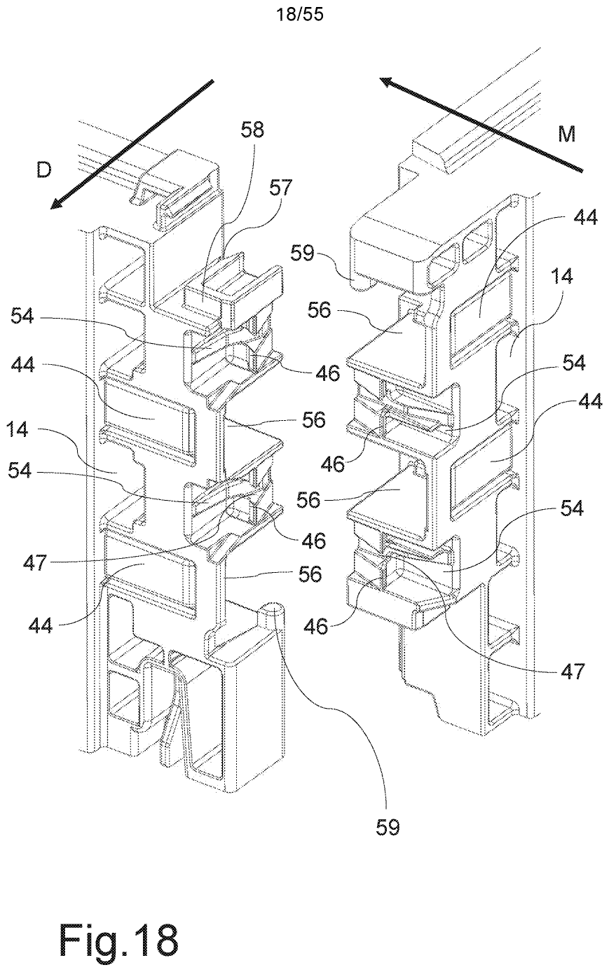

To facilitate assembly, some of the connecting blocks 54 of a wall element 14 are provided with an insertion bevel 58 which can interact with an associated guiding projection 59 of the corresponding receiving opening 56 of the other wall element 14. The insertion bevel 58 and the guiding projection 59 are designed so that they cooperate with each other during assembly but are moved past each other when fully assembled. This makes it possible for each corner section to be assembled in one direction but disassembled in a direction perpendicular thereto. This is indicated in FIG. 18 by the two arrows M and D.

The corner section can be assembled by pushing the wall element 14 on the right in FIG. 18 in the direction of the arrow M onto the wall element 14 on the left in FIG. 18. The insertion bevel 58 is guided by the guiding projection 59. In the fully assembled state, the guiding projection 59 lies within the insertion bevel 58. There, in a direction approximately perpendicular to the direction of extension of the insertion bevel 58, a release groove 57 is formed through which the guiding projection 59 can move when the wall element 14 on the left in FIG. 18 is pulled off in the direction of the arrow D from the right wall element 14 during disassembly.

In the second variant embodiment, the wall elements 14, including the module latching parts 54, are also designed so that they can be manufactured in an injection molding tool without slides.

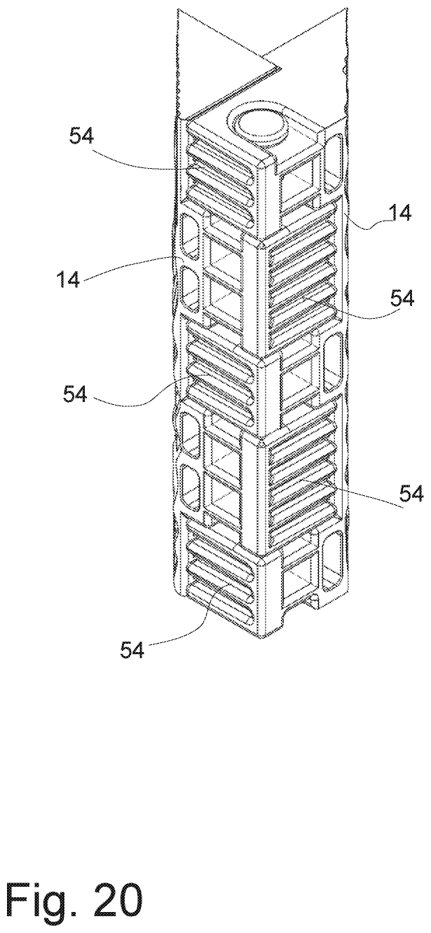

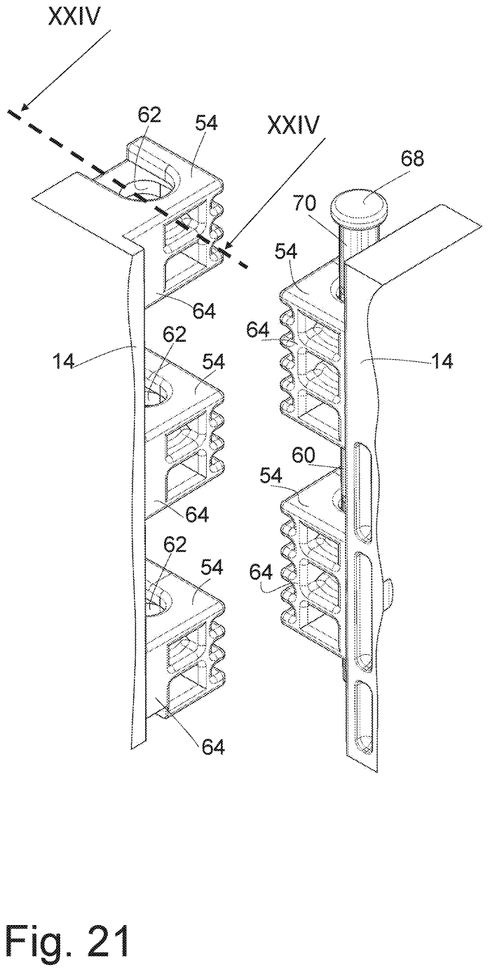

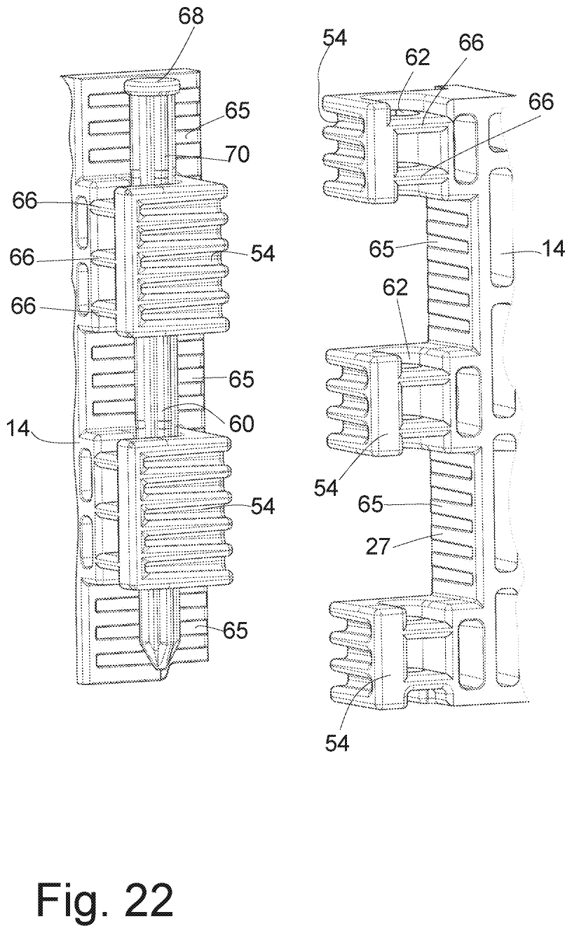

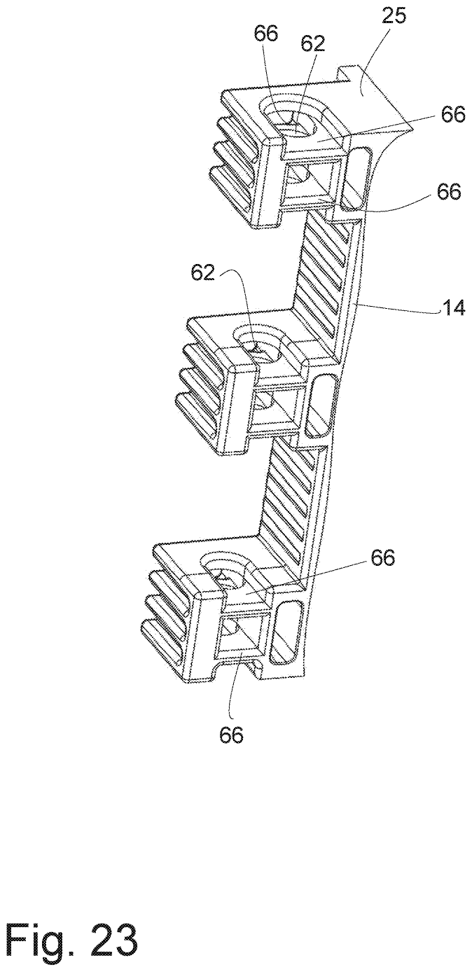

A third variant embodiment of a corner connection for the wall elements 14 is described below with reference to FIGS. 20 to 25. The same reference numerals are used for the components and features known from the first and second variant embodiments of the corner connection, reference being made to the above explanations in this respect.

The difference between the third variant embodiment on the one hand and the first and second variant embodiments on the other hand is that in the third variant embodiment, the wall elements 14 are connected to each other by means of a separate connecting element 60.

In the third variant embodiment, too, the complementary module latching parts are formed from a total of five connecting blocks 54. These have a rectangular cross-section with three free side surfaces arranged at an angle of 90° to each other.

In the variant embodiment shown, two connecting blocks 54 are used at one end of the wall element 14 and three connecting blocks 54 are used at the other end. Counting the connecting blocks 54 in one row, the first, third, and fifth connecting blocks 54 of the connecting blocks 54 of a corner connection are assigned to one wall element 14, and the second and fourth connecting blocks 54 are assigned to the other wall element 14.

The advantage of this number of connecting blocks 54 is that, when a wall element 14 is subjected to loads vertically relative to the adjacent wall element 14, the same number of side surfaces of the connecting blocks 54 are available for load transfer, namely two side surfaces in this case, regardless of the direction of the load. The same advantage would be achieved in all other ‘odd’ combinations of connecting blocks 54, i.e. with one and two connecting blocks 54, with three and four connecting blocks 54, etc.

Each connecting block 54 has a continuous opening 62 to accommodate the connecting element 60, wherein the openings 62 of the connecting blocks 54 are aligned concentrically with respect to each other at one end of each wall element 14.

The side surface of each connecting block 54, arranged in extension of the inner side of each wall element 14, forms an arresting surface 64, which is respectively aligned tangentially to the common center axis of the openings 62 of the connecting blocks 54 at one side edge. All arresting surfaces 64 are located at the same distance from the center axis. The arresting surfaces 64 are intended and designed to cooperate with the side surfaces 65 at the side edges of the other wall element 14.

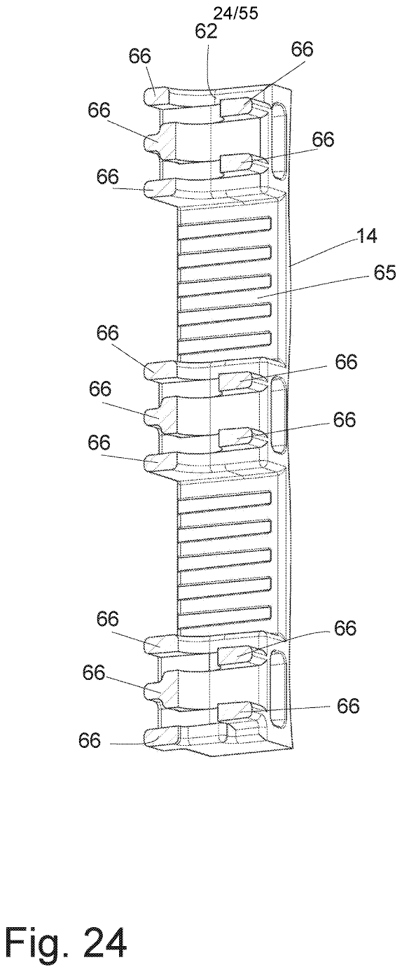

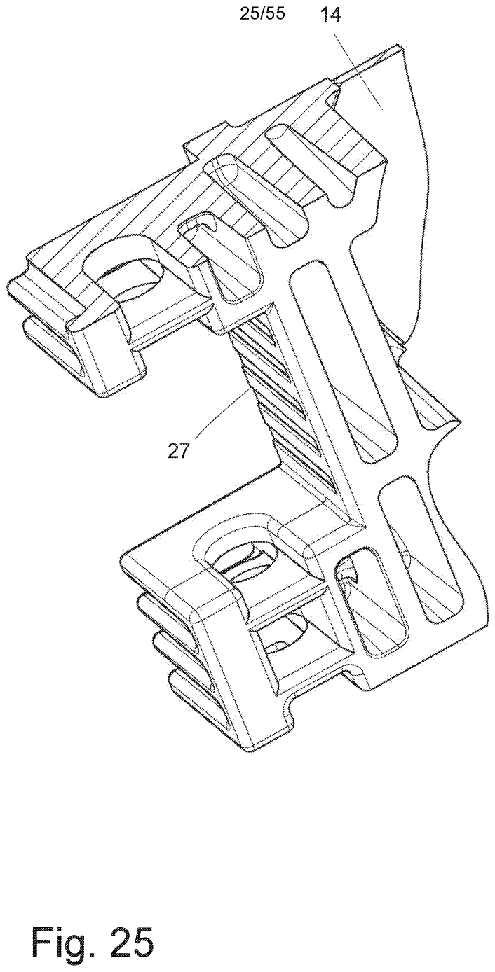

The connecting blocks 54 on the two side edges of each wall element 14 are formed from a plurality of thin walls 66 which extend alternately from the outside and the inside of the wall element 14 (see in particular FIGS. 24 and 25). This makes it possible to manufacture the wall elements 14 without requiring slides in the injection mold.

To assemble a module 12, the wall elements 14 are put together so that the wall elements 14 interlock like a comb. The connecting element 60 is then pushed through the openings 62.

The connecting element 60 has the shape of a nail having a stop head 68. Adjacent to the stop head 68, the nail includes a clamping section 70 having a diameter which is slightly larger than the diameter of the remaining section of the connecting element 60 up to the free end applied by the stop head 68. This allows the connecting element 60 to be pushed freely through the openings 62 until the clamping section 70 is pressed into the opening 62 of the uppermost connecting block 54 for the last small part of the insertion path.

The arresting surfaces 64 are dimensioned and arranged such that, when the connecting element 60 is inserted, they rest against the associated side surface 65 of the adjacent wall element 14. This fixes the wall elements 14 at an angle of 90° to each other.

The connecting blocks 54 can also be dimensioned such that it is possible to connect a wall element 14 to a second wall element 14 in extension of the latter. In this case, the outer surface of the connecting blocks 54 pointing away from the center of the wall elements 14 acts as an arresting surface 64.

By mounting two wall elements 14 in this way in the same plane, a rectangular manhole 10 having two longer and two shorter side walls 16 can be constructed from identical wall elements 14, for example with six wall elements 14 per module 12.

To separate the wall elements 14 from each other again, the connecting element 60 is removed from the openings 62. For this purpose, the free end of the connecting element 60 can be struck with a punch or a similar tool. This is easily possible as the free end of the connecting element 60 in the lowermost connecting block 54 is exposed. Once the connecting element 60 has been moved out so far that the clamping section 70 is no longer inside the uppermost connecting block 54, the connecting element 60 can be pulled out by hand.

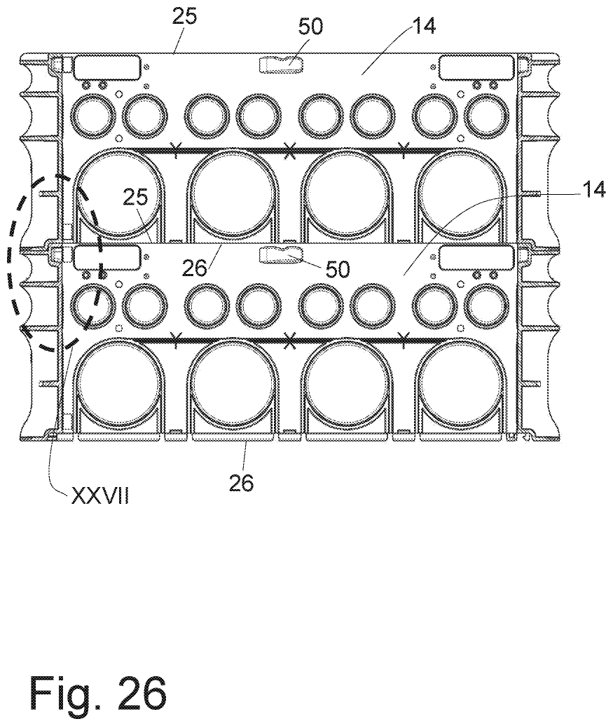

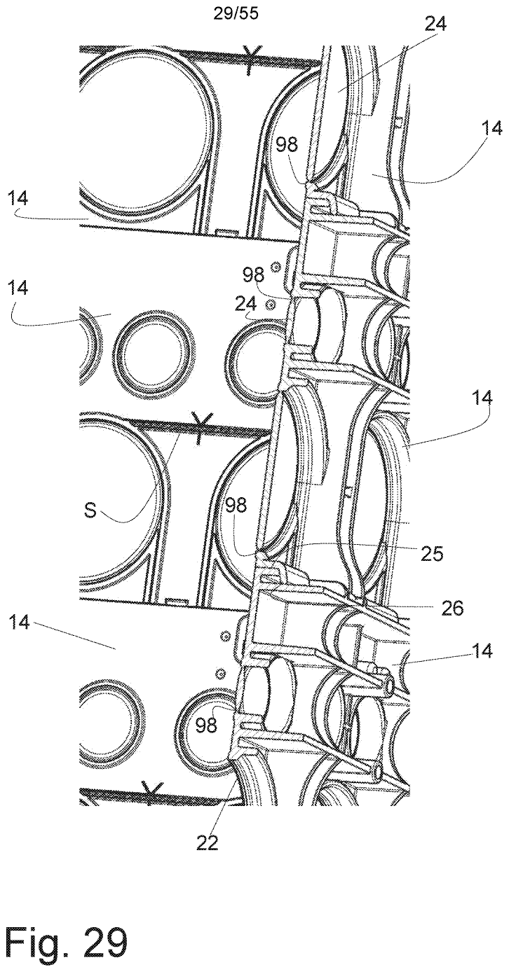

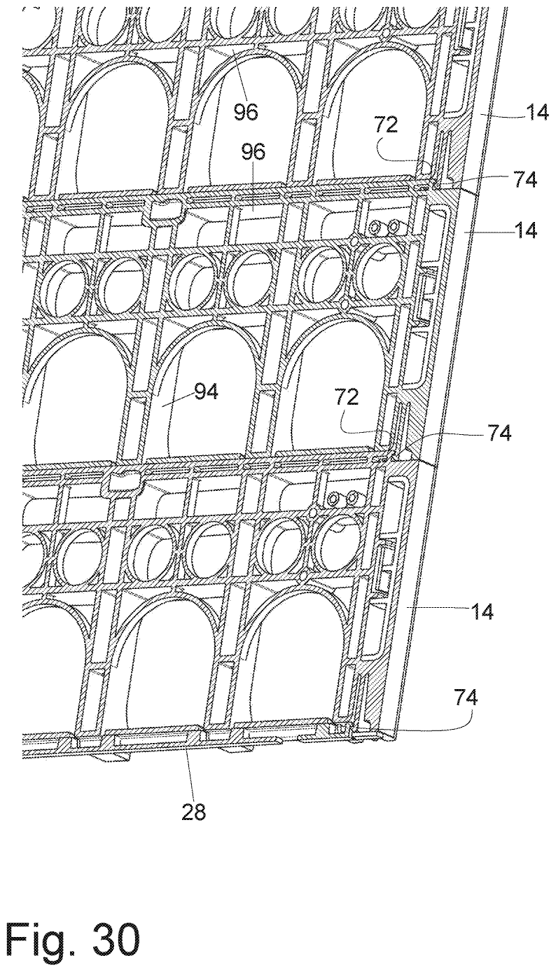

With reference to FIGS. 26 to 30, it is explained below how the modules 12 are connected to each other in the vertical direction. This applies regardless of the manner in which the wall elements 14 are connected to each other at the corners of a module 12, and also regardless of whether the modules 12 have a square cross-section or a rectangular cross-section with two longer and two shorter sides.

The wall elements 14 have a latching element 72 on the upper edge 25 and a latching feature 74 on the lower edge 26. When the modules 12 are placed on top of each other, the latching feature 74 of the lower edge 26 of the upper module 12 latches into the latching element 72 of the upper edge 26 of the lower module 12.

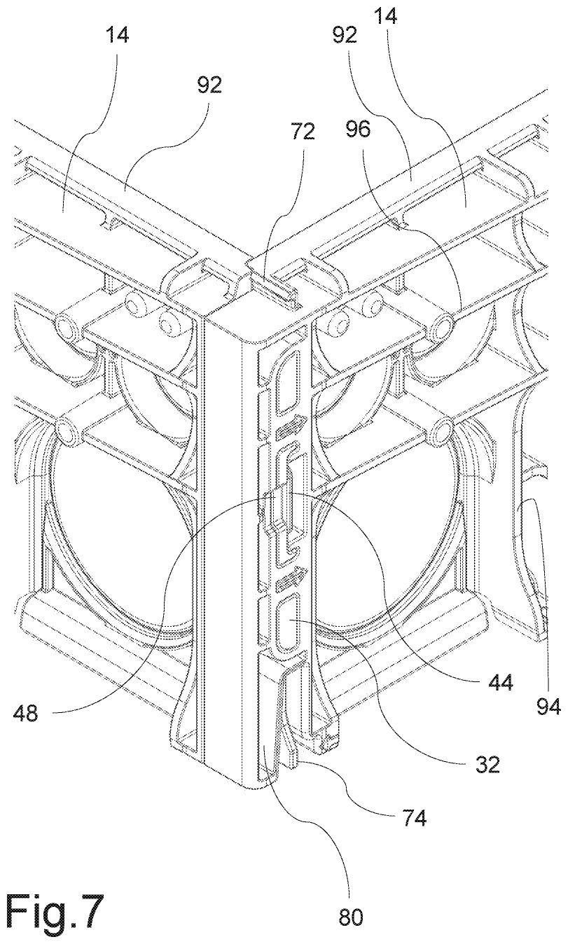

In the example embodiment shown, the latching element 72 is a rigid latching nose (see in particular FIGS. 7 and 11), which is arranged close to the upper edge 25, laterally above the plug-in receptacle 34, so as to project laterally.

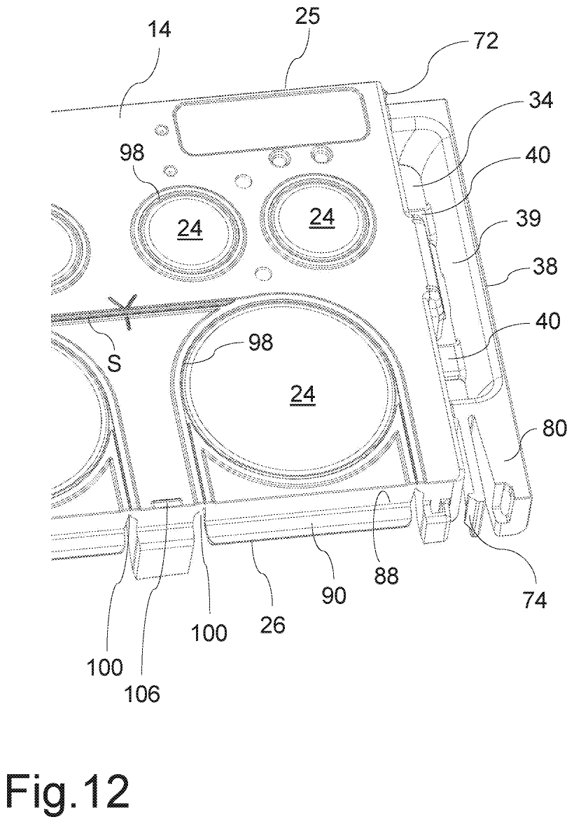

The latching feature 74 is a latching tab (see in particular FIGS. 11 and 12) which can be elastically deformed from a latching position into a release position, which extends vertically from the lower end of the bracket 38, and the free end of which is located near the lower edge 26 of the wall element 14.

A skirt 80 is arranged laterally outside the latching feature 74, so that a window 82 is formed, within which the latching feature 74 is arranged.

The latching element 72 and the latching feature 74 are arranged vertically one above the other at the same end of a wall element 14, and there is only one latching element 72 and one latching feature 74 per wall element 14. In the assembled state, the latching feature 74 of a wall element 14 connects the module 12, of which the corresponding wall element 14 is a part, in the corner section to the latching element 72 of the wall element 14 of the module 12 below arranged therebelow.

As can be seen in FIG. 11, both the latching element 72 and the latching feature 74 lie within the outer contour of the wall element 14. The latching element 72 is located below the upper edge 25 and within the bracket 38, and the latching feature 74 is located above the lower edge 26 of the wall element 14 and within the bracket 38. This protects the latching element 72 and the latching feature 74 from damage during transport of the wall elements 14.

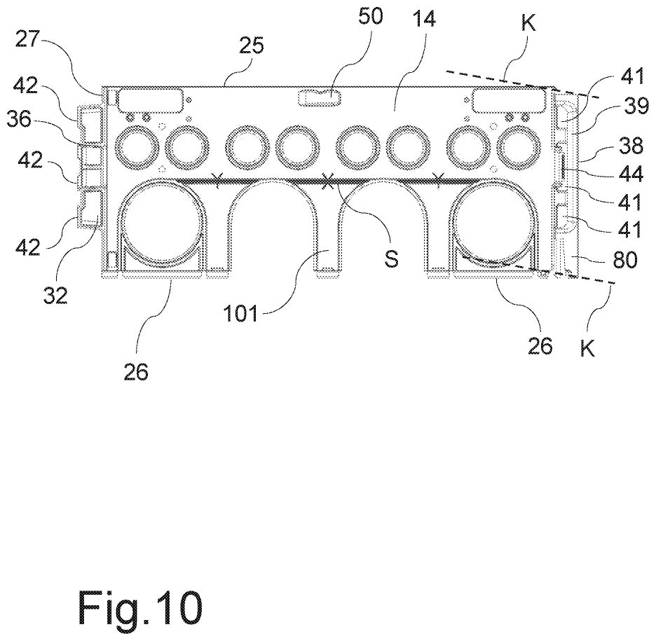

The latching element 72 and the latching feature 74 have contact surfaces 84 which cooperate with each other when the modules 12 are placed on top of each other. The contact surfaces 84 are inclined relative to the longitudinal direction of the latching feature 74 and thus relative to the vertical direction in which any tensile loads act (see the plane K of the contact surfaces 84, which is shown exaggeratedly inclined in FIG. 10 for clarification purposes), i.e., at an angle other than 90°. The contact surfaces 84 are inclined such that, when tensile loads act on the latching feature 74, the latching feature 74 is acted upon in the latching position, i.e., to the left in relation to FIGS. 10 and 11.

An actuating recess 86 is provided at the lower edge 26 of the wall element 14 on the side of the latching feature 74 at the edge of the window 82 (see FIG. 8). This makes the latching feature 74 easily accessible so that it can be pressed into the release position by an installer when the modules 12 are to be separated from each other. In addition to the window 82, an arrow is also placed on the wall element 14, which supports intuitive operation.

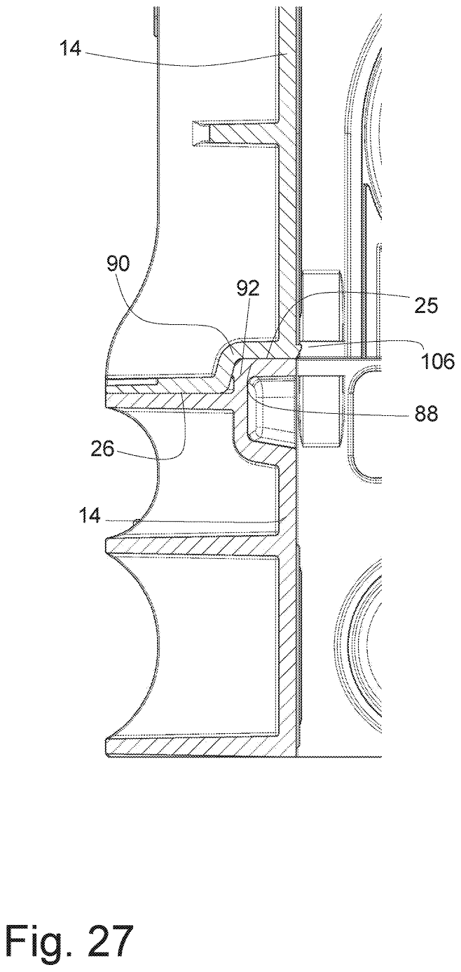

At the lower edge 26, each wall element 14 is provided with a bearing surface 88 (see in particular FIG. 27), which is adjoined on the outside by a centering skirt 90. This has a height of approx. 10 mm and, when the modules 12 are mounted on top of each other, engages over a receiving edge 92 formed on the upper edge 25 of each wall element 14. The latching element 72 is located on the side of this receiving edge 92.

When the modules 12 formed from the wall elements 14 are stacked on top of each other in a first configuration, the bearing surface 88 is placed on the receiving edge 92. This results in an overlap of the upper section of the lower wall element 14 with the lower section of the upper wall element 14, so that the latching element 72 and the latching feature 74 can engage with each other, though both are located within the outer contour of the wall elements 14.

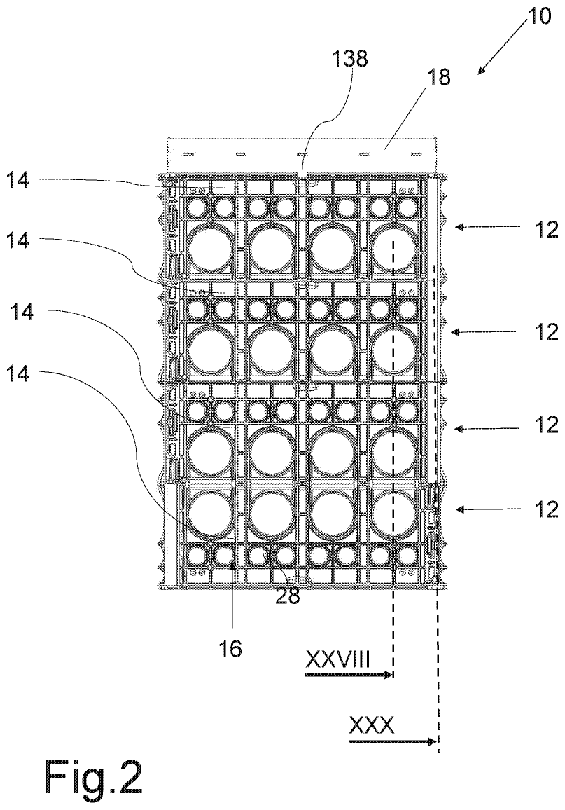

The first configuration can be seen, for example, in FIG. 2 for the connection between the uppermost module 12 and the second uppermost module 12, as well as the connection between the second uppermost module 12 and the module 12 therebelow. The first configuration is also shown in FIG. 4 for all modules 12 used there.

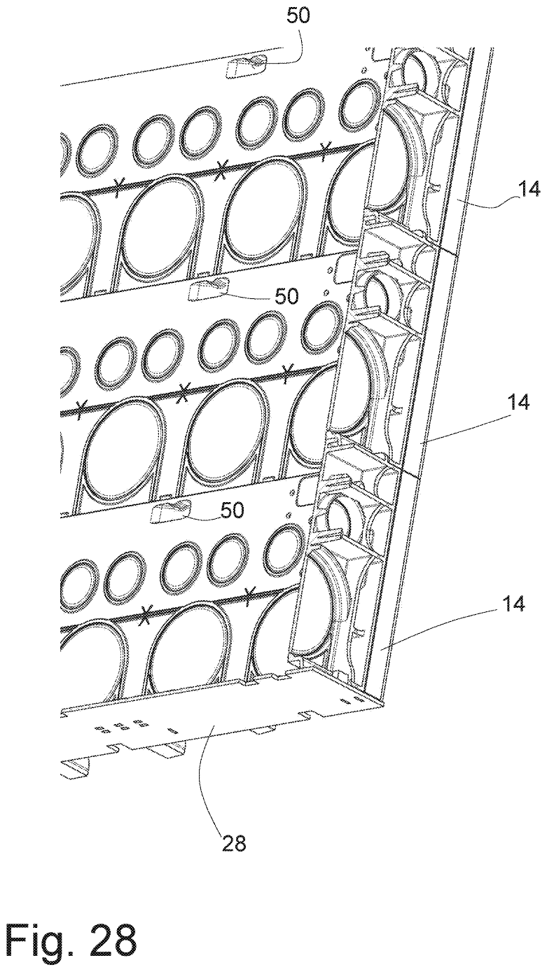

The latching features 74 of the wall elements 14 of the lowermost module 12 of a manhole 10 can also be used to attach the base plate 28 (see FIG. 28). The base plate 28 is provided with latching elements which correspond to those arranged on the upper edge 25 of the wall elements 14.

The base plate is also provided with latching hooks which can engage with the underside of the lowermost module.

When vertical loads act on the manhole cover 20, these are transferred to the frame 18 and from there to the wall elements 14. The forces are transferred downwards in the wall elements 14. For this purpose, the wall elements 14 have on the one hand wall sections which are continuous in the vertical direction. On the other hand, the wall elements 14 are provided with vertically extending reinforcing webs 94.

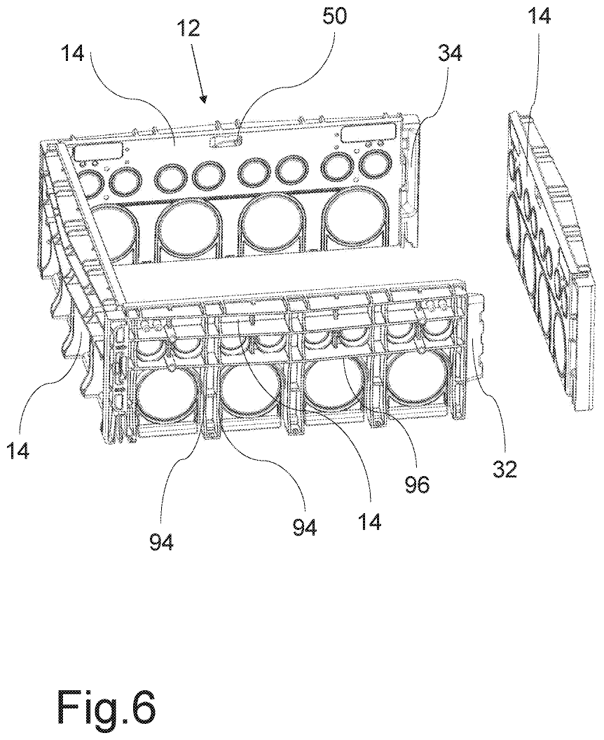

In addition to the vertical loads, loads also act on the side walls 16 of the manhole 10 in a direction running perpendicular to the direction of extension of the side walls 16 from the outside to the inside. These loads result mainly from earth pressure when the manhole 10 is buried. Horizontal stiffening ribs 96 are provided to be able to absorb these loads. They have their greatest height in the middle of each wall element 14 (see, for example, FIG. 6).

To allow lines to be inserted into the interior of the manhole 10, each wall element 14 is provided with a plurality of passage openings 22, 23.

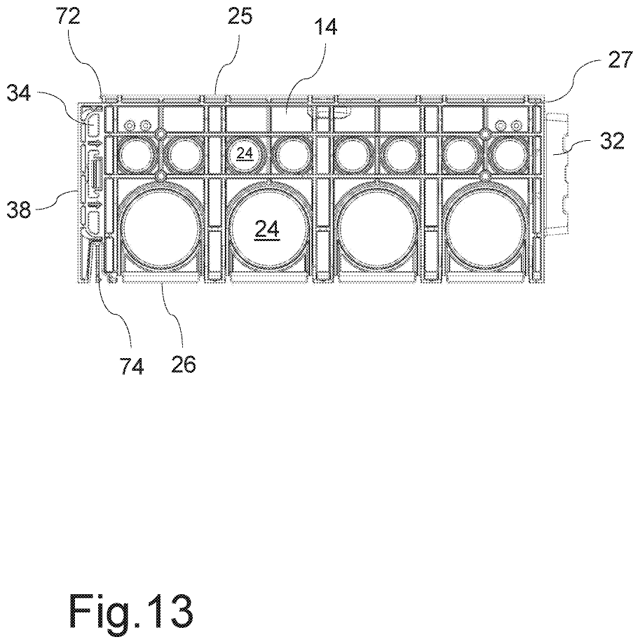

In the example embodiment shown, each wall element 14 (see, for example, FIG. 13) has a row of large circular passage openings 22 along its lower edge 26, which here have a diameter of 110 mm.

Above the row of large passage openings 22 is a row of small circular passage openings 23, which here have a diameter of 50 mm. Two small passage openings 23 are arranged in a vertical segment in which a large passage opening 22 is arranged.

Above the row of small passage openings 23 is a wall section in which no passage openings are provided. This is advantageous in terms of the distribution of vertically applied loads.

In the delivery state of the wall elements 14, each passage opening 22, 23 is closed by a cover 24, which is connected to the surrounding wall sections via a predetermined breaking point 98. In the area of the predetermined breaking point 98, the wall thickness is in the order of 2.0 mm.

During installation of the manhole 10, the covers 24 can be removed from the side wall 16 where a line is to be inserted into the manhole 10. The covers 24 can be knocked out using a hammer, for example.

A special feature of the wall elements 14 is that the lower edge 26 of the wall element 14 can be removed in the area of the large passage openings 22. This creates a passage opening 22 that is open at the bottom, allowing lines to be built over. “Built over” means that the manhole 10 can be placed on top of a line that has already been laid and the line does not have to be inserted laterally into a manhole 10 that has already been placed in a pit.

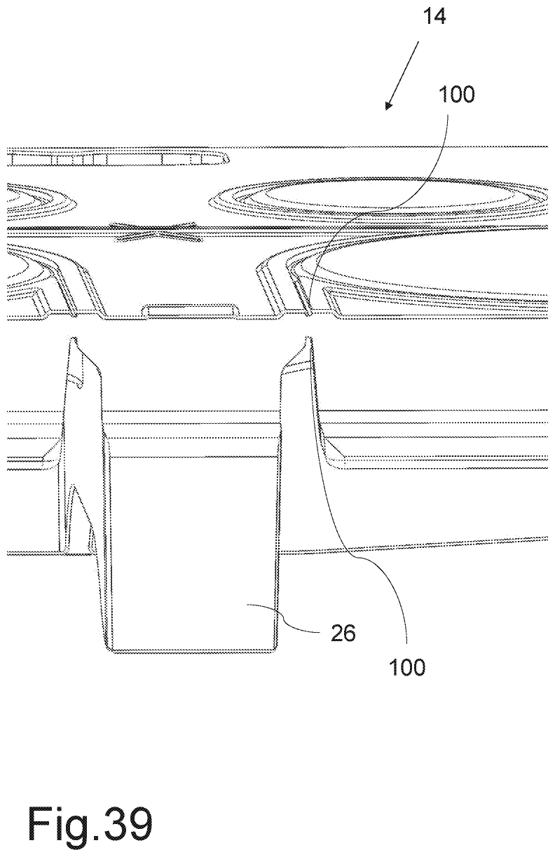

To be able to adapt the wall element 14 flexibly to the respective requirements on site, two weakening zones 100 extend from the lower edge 26 of the wall element 14 to the corresponding passage opening 22. The weakening zones 100 run tangentially into the predetermined breaking point 98 of the passage opening 22 (see in particular FIG. 12 and FIG. 39).

The wall thickness in the weakening zones 100 is approximately 3 mm.

Outside the weakening zones 100 and outside the predetermined breaking points 98, the wall thickness of the wall elements 14 is approximately 6 mm.

To prevent the lower edge 26 of a wall element 14 between two weakening zones 100 from being accidentally broken out when the cover 24 of the corresponding passage opening 22 is removed, the predetermined breaking points 98 of the covers 24 of the large passage openings 22 are designed with a further reduced wall thickness on their side facing the lower edge 26. In the example embodiment, the wall thickness is approximately 0.6 mm instead of the otherwise existing 2 mm.

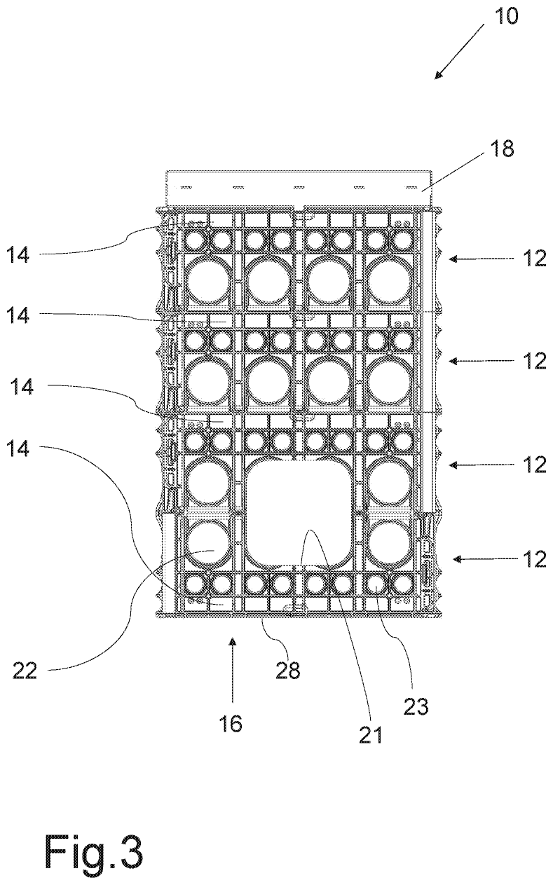

The modules 12 can also be placed on top of each other in a second configuration in which the lower edge 26 of one module 12 is placed on the lower edge 26 of another module 12, which thus becomes the edge located on the upper side of the lower module 12. The second configuration is shown in FIG. 3 for the lowermost module 12 and the second lowermost module 12. The lowermost module 12 is mounted “upside down” here.

When two modules 12 are connected to each other in the second configuration, the large rectangular passage opening 21 can be obtained. To this end, the lower edge 26 is removed in a first step for two adjacent large passage openings 22 (see FIG. 10). Then the center web 101 remaining between the passage openings 22 is removed. For this purpose, a saw line S is provided along which an installer can saw using, for example, a jigsaw.

Once the center web 101 has been removed, one half of the rectangular passage opening 21 is obtained. At a corresponding location on a second module 12, the lower edge 26 of two large passage openings 22 and the center web 101 of the saw line S are also removed.

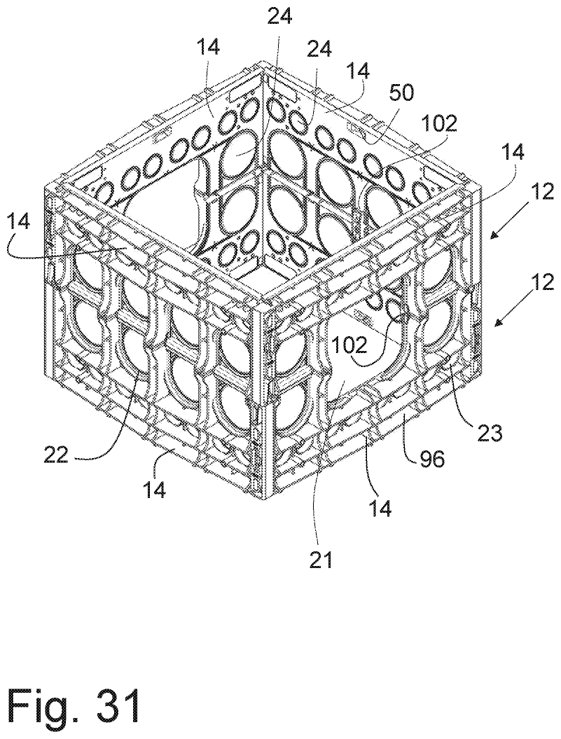

When the two appropriately prepared modules 12 are then connected to each other in the second configuration, the large rectangular passage opening 21 is obtained, as can be seen in FIG. 31. This has dimensions of approximately 260 mm×260 mm.

The large passage opening 21 can be formed not only in the center of a side wall 16 of the manhole 10, but also on the right or left side. It is also possible to provide two large passage openings 21 next to each other. To this end, the two center webs 101 marked with “Y” in FIG. 10 must be removed.

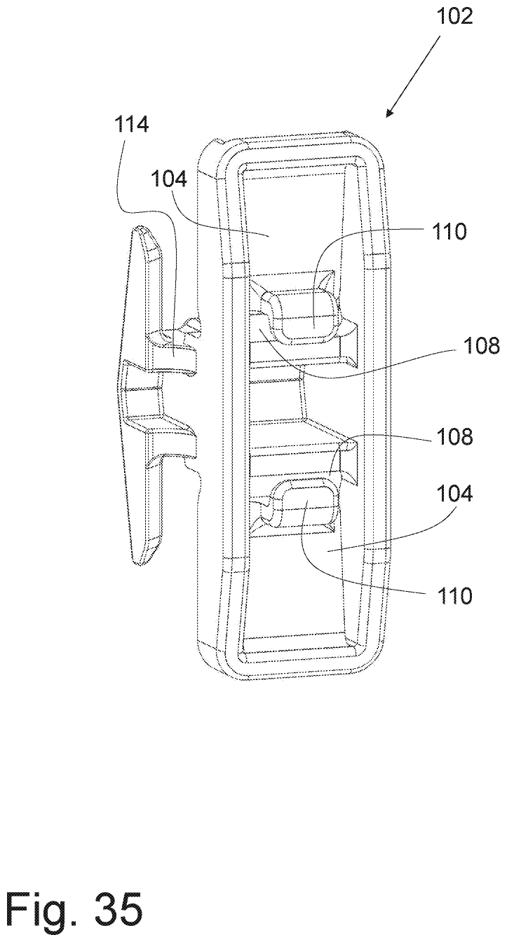

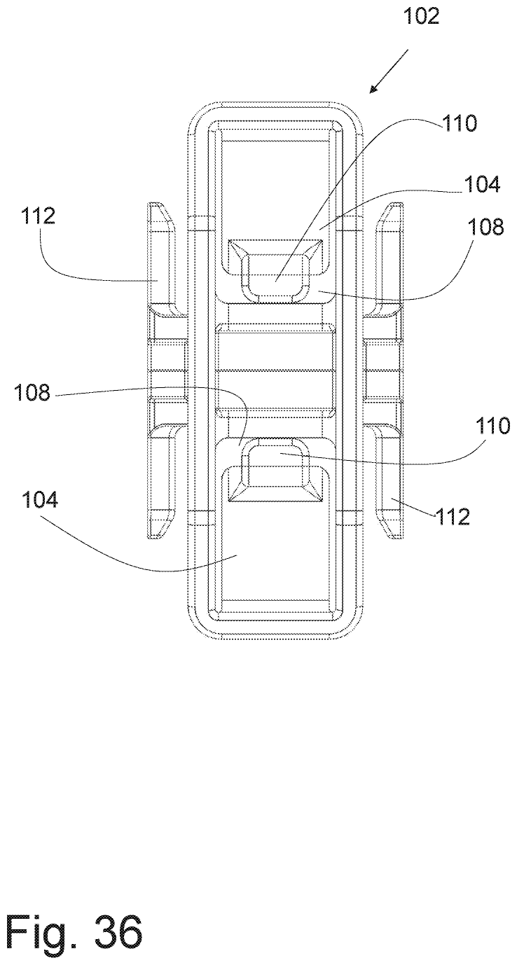

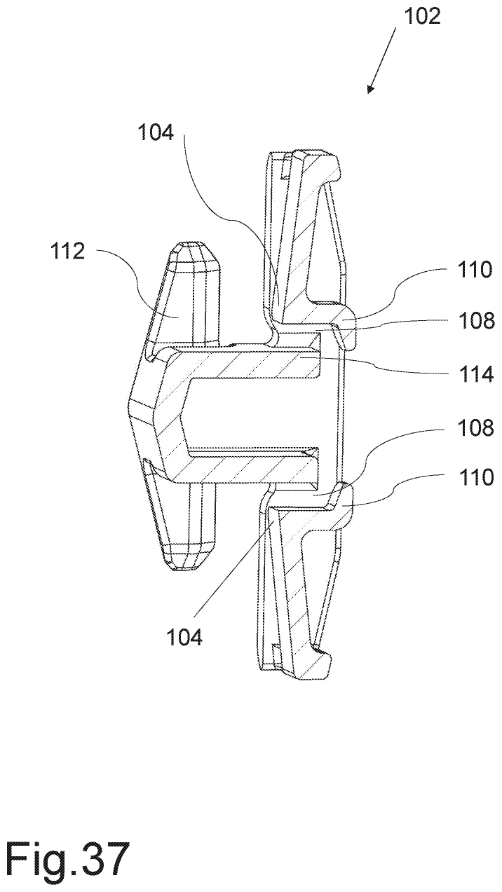

Separate connector parts 102 are provided to connect two modules 12 to each other in the second configuration. These are shown in FIGS. 35 to 37.

The connector part 102 is designed here as a connecting clip.

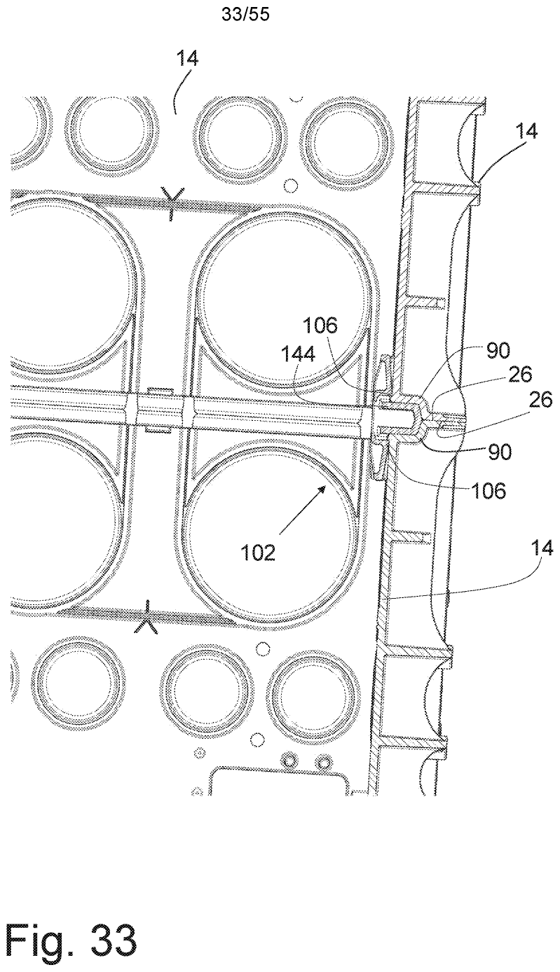

Each connector part 102 has two connecting tabs 104 which cooperate with connecting projections 106 (see FIGS. 27 and 33) arranged adjacent to the lower edge 26 of the wall elements 14. The connecting tabs 104 are arranged within window-like recesses 108 so as to be protected.

Each connecting tab 104 is provided with a gripping hook 110 which allows an installer to pull the connecting tabs 104 into a release position when the modules 12 are to be separated from each other.

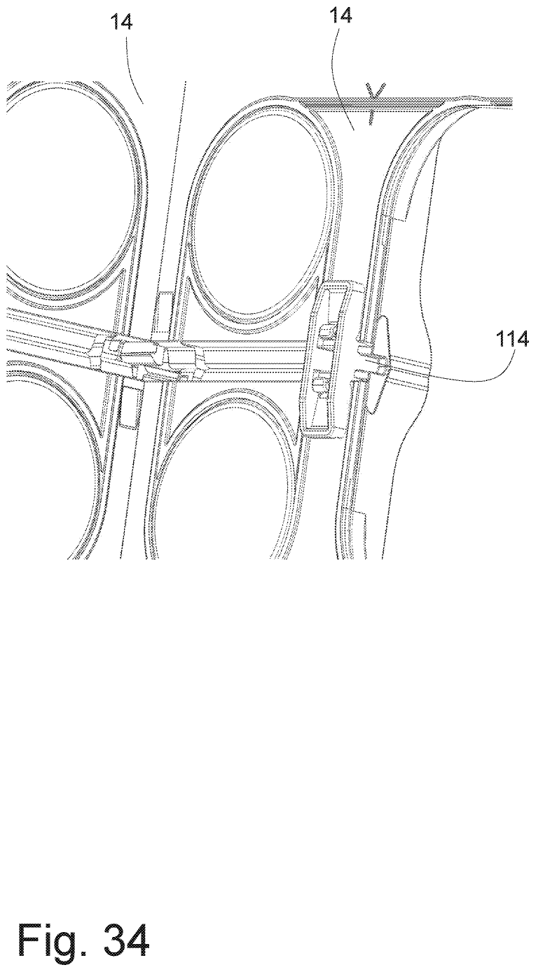

In the assembled state, the connecting tabs 104 are arranged on the inside of the modules 12. To guide the modules 12 relative to each other, the connector part 102 has two retaining webs 112 which, when assembled, are located on the outside of the modules 12 (see FIG. 34). On the inside, the modules 12 are guided by the center section 114 of the connector part 102, which is located in the free space between two centering skirts 90 facing each other (see FIG. 33).

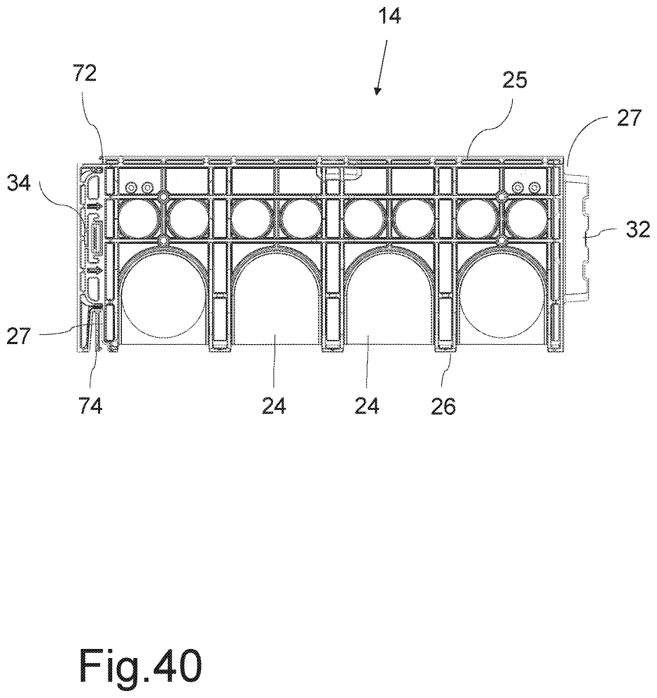

A wall element 14 for a manhole 10 according to a third embodiment is described below with reference to FIGS. 39 to 42. The same reference numerals are used for the components and features known from the first and second embodiments, reference being made to the above explanations in this respect.

The difference between the wall element 14 of the first and the second embodiment and the wall element 14 of FIGS. 39 to 42 is that the wall element 14 of FIGS. 39 to 42 does not have a centering skirt 90 at the lower edge 26, but only a straight wall section.

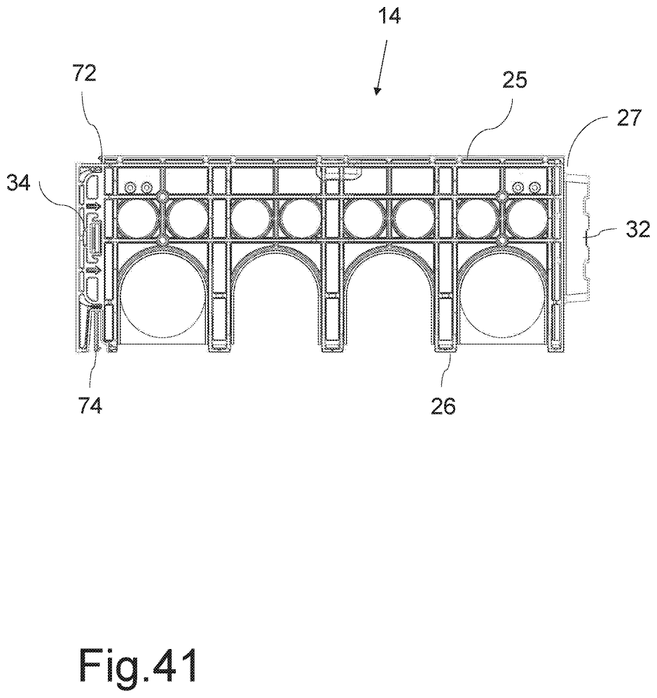

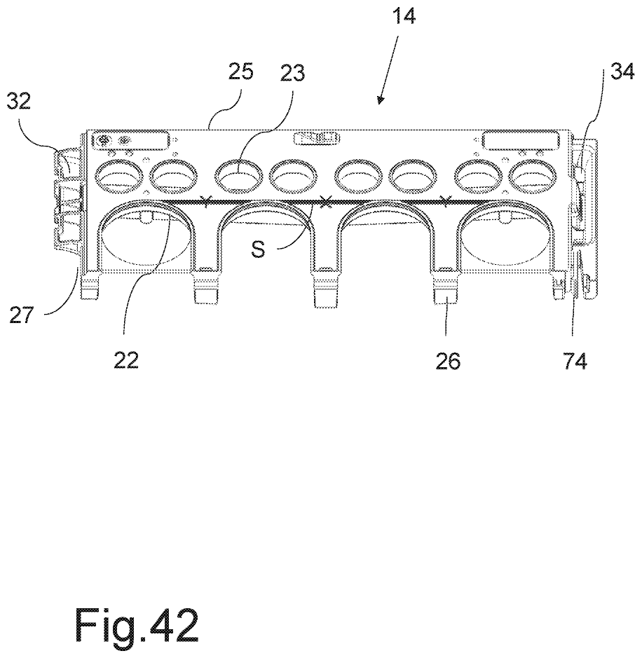

As can be seen in FIG. 42, three different passage openings are provided in this wall element 14, namely smaller passage openings 23 and, below these, larger passage openings 22, some of which open towards the lower edge 26 of the wall element 14 when a cover 24 closing the passage openings 22 in the delivery state is removed (see FIG. 41).

Here, too, the center web 101 located between two larger passage openings 22 can be removed to create either a wider passage opening 22 which is open at the lower edge 26 and by means of which lines can be built over, or a very large passage opening 21 if a lower module 12 is attached upside down to the module 12 above it.

All wall elements 14 described here can also be used with the manhole 10 of the second embodiment by making two of the four wall elements 14 of a module 12 longer than the other two. All other features relating to the connection of the wall elements 14 at the corners of a module 12, the connection of the modules 12 to each other, and the various passage openings 21, 22, 23 can be used in all embodiments.

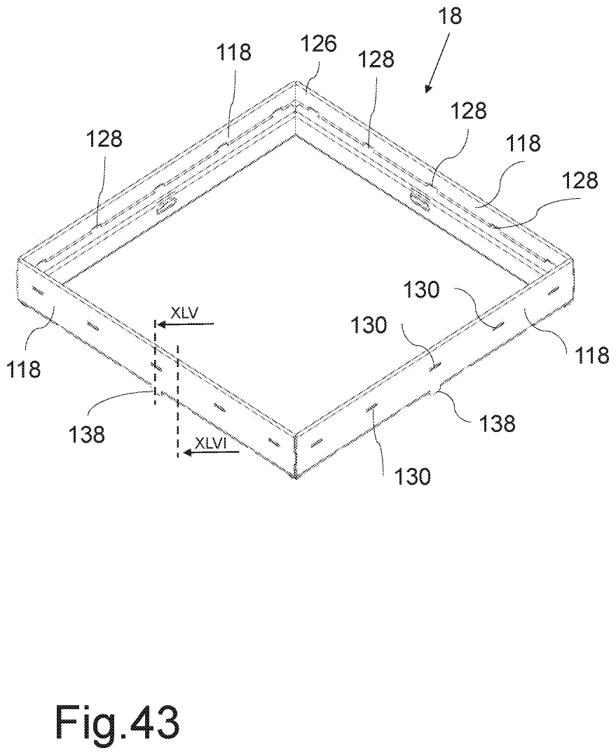

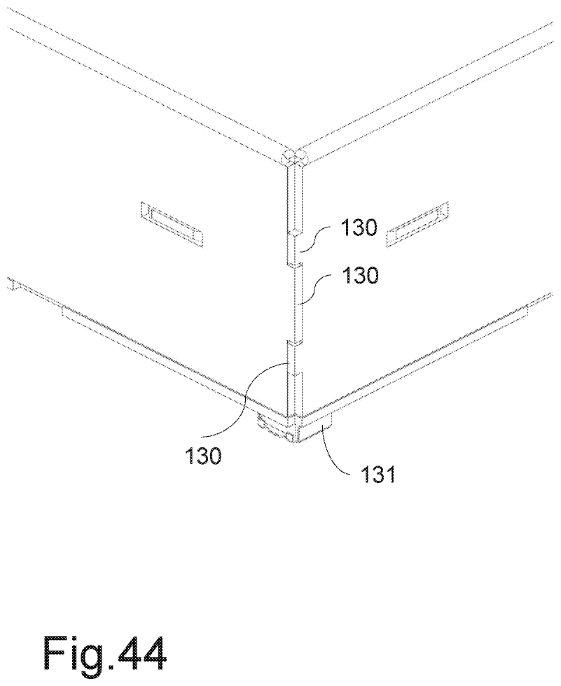

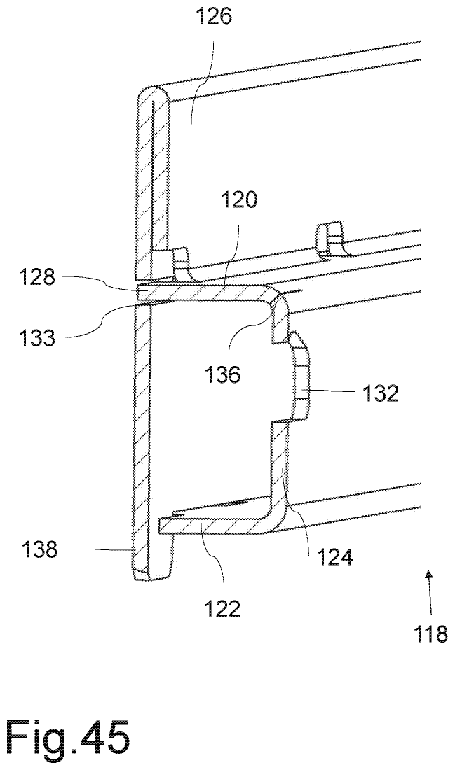

The frame 18 arranged on the uppermost module 12 of a manhole 10 is explained below with reference to FIGS. 43 to 46.

The frame 18 has a plurality of interconnected segments 118, each of which forms one side of the frame 18. In the square frame 18 for the manhole 10 of the first embodiment, all segments 118 have the same length. In the rectangular frame 18 for the manhole 10 of the second embodiment, two of the segments 118 have a greater length than the others.

Each segment 118 is a sheet metal bent part having a hollow load-bearing cross-section which has a receiving leg 120 on the upper side, which is intended to accommodate a manhole cover, and a support leg 122 on the underside, which is intended to be supported on the upper edge 25 of the manhole 10, more precisely on the receiving edge 92.

The support leg 122 and the receiving leg 120 are connected to each other on the inside of the segment 118 by an inner leg 124.

The receiving leg 120 is adjoined by a skirt 126, which serves to guide the manhole cover 20 when it is placed on the receiving leg 120. The skirt 126 is formed by two sheet metal layers folded on top of each other. The outer sheet metal layer extends from the fold downwards to the support leg 122, so as to form the outer leg of the load-bearing cross-section.

For stiffening, the receiving leg 120 is provided with a plurality of support noses 128 which protrude into recesses 130 in the outer sheet metal layer. As a result, loads acting on the receiving leg 120 are transferred in part directly into the outer sheet metal layer and from there into the support leg 122 and do not have to be absorbed by the skirt 126. The other part of the loads is transferred from the inner leg 124 to the support leg 122.

The support leg 122 transfers vertical loads into the receiving edge 92 of the wall elements 14 and thus directly vertically into the area of the wall elements 14, which have the highest strength.

Below the receiving edge 92, the closed wall of the wall element 14 (apart from open passage openings 22) extends downwards to the lower edge 26. From there, the acting forces can in turn be transferred directly in the vertical direction. The stiffening webs 94 increase the strength against vertical loads.

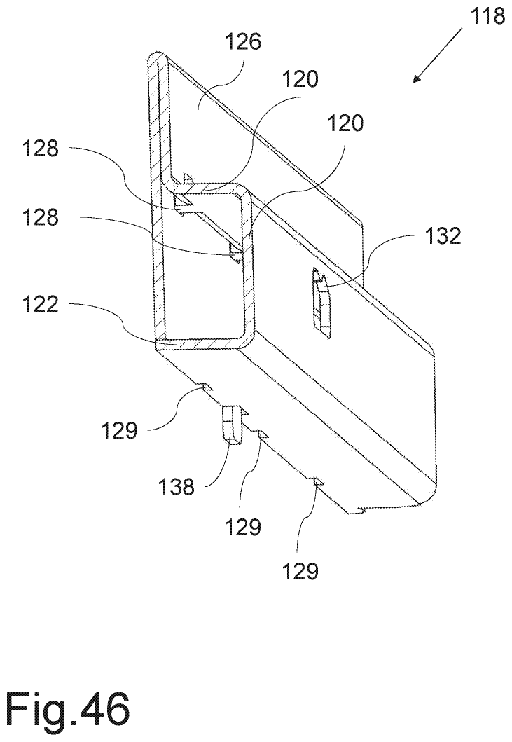

The outer sheet metal layer and the support leg 122 can be welded together. FIG. 46 schematically shows a plurality of welding points 129.

In contrast to the embodiment shown, welding could be carried out on the outside of the frame 18.

In the embodiment shown, the outer sheet metal layer rests on the support leg 122, which extends to the outer edge of the frame 18.

The support leg 122 could be pulled outwards to such an extent that, when the manhole 10 is installed, the upper layer of the soil surrounding the manhole 10 or the floor covering (asphalt, concrete, etc.) rests thereon, thus creating a lift-out protection for the frame 18.

The lift-out protection can also be created by making the outer sheet metal layer longer than shown in FIGS. 43 to 46 and bending the edge thereof outwards away from the load-bearing section.

As an alternative to the embodiment shown, the support leg 122 could be designed shorter by the thickness of the outer sheet metal layer, and the outer sheet metal layer could be designed longer by the thickness of the support leg 122. In this case, the joint between the outer sheet metal layer and the support leg 122 is located on the underside of the frame.

Each segment 118 consists of a single blank from sheet steel having a thickness of approx. 3 mm.

The individual segments 118 are manufactured separately from each other and welded together at the corners of the frame 18. To be able to position the segments 118 correctly relative to each other before welding, the ends of the segments 118 have one guiding tab 133 and two guiding tabs 133, respectively, so that the one guiding tab 133 of one segment 118 can be received between the two guiding tabs 133 of the adjacent segment 118.

It is also conceivable to manufacture all segments 118 together from a single blank, which is bent by 90° at three corners and welded at the fourth corner, so that the closed frame 18 is obtained.

In the area of the corners, receiving openings are provided for a cage nut 131, which is part of a height adjustment mechanism.

Furthermore, at least two of the segments 118 each have a locking opening 132 formed in the inner leg 124. A bolt, which is part of the locking mechanism 52 mounted in the manhole cover 20, can engage in the locking opening 132.

To ensure that the inner leg 124 does not deform in the area of the locking opening 132 upon bending, a notch 136 is formed in the receiving leg 120 at the transition to the inner leg 124 over the length over which the locking opening 132 also extends.

In the embodiment shown in the figures, the outer sheet metal layer is provided with at least one and preferably a plurality of centering noses 138 at the lower edge thereof. These constitute centering features cooperating with a complementary centering feature provided on the manhole 10, more precisely on the wall elements 14.

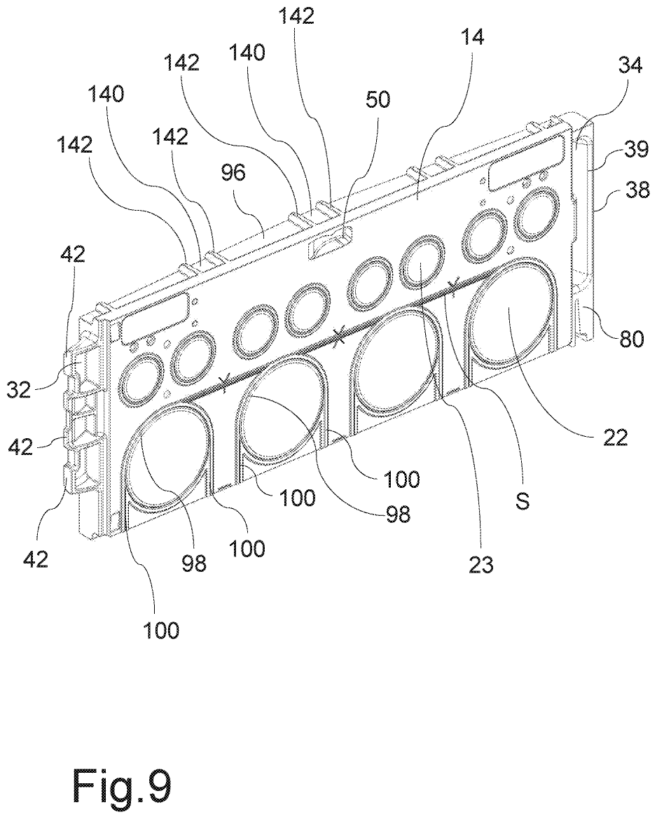

Each wall element 14 has a plurality of grooves 140 on its upper side next to the receiving edge 92 (see, for example, FIG. 9), which extend perpendicular to the plane of the inner side of the wall element 14. Each groove 140 is formed between two webs 142 which extend parallel to each other and adjoin the receiving edge 92.

The centering noses 138 engage in these grooves 140 (see FIGS. 1 to 4). The grooves 140 form a sliding guide for the centering noses 138, so that movement of the upper edge 25 of the upper module 12 relative to the centering noses 138 is possible in a direction perpendicular to the corresponding side wall 16. This sliding movement can compensate for tolerances. In addition, the frame 18 is not subjected to stress if the side walls 16 of the manhole 10 are slightly deformed inwards by the earth pressure acting thereon.

If lines having a diameter smaller than or equal to the diameter of the corresponding passage opening 22 are fed through the passage openings 22, an adapter plug 143 can be used to obtain an opening adapted to the diameter of the line. The advantage is that the passage opening 22 is thus essentially sealed. If the lower edge of a wall element 14 is removed between two weakening zones 100, the free space present here can also be sealed.

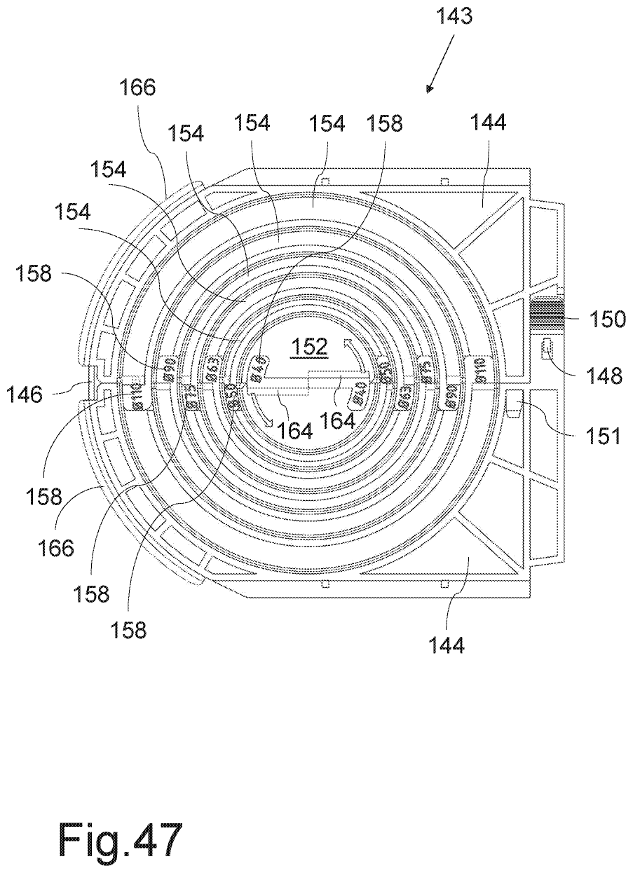

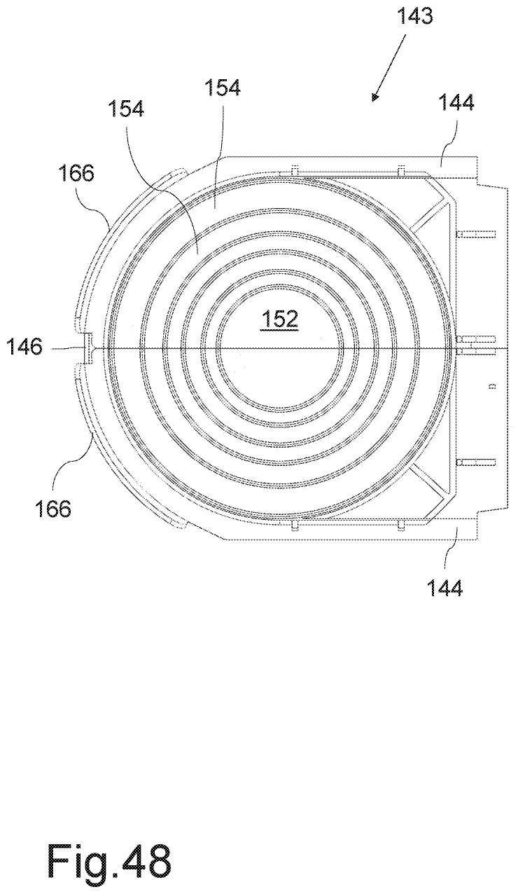

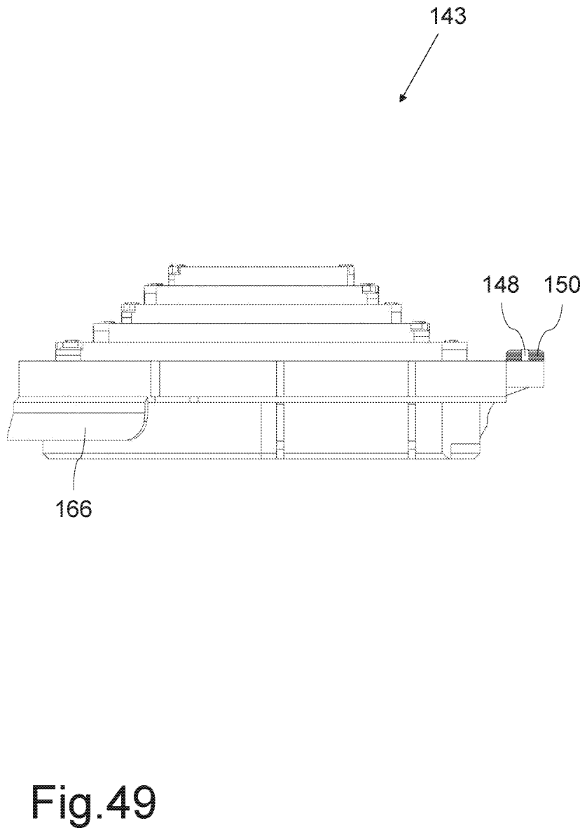

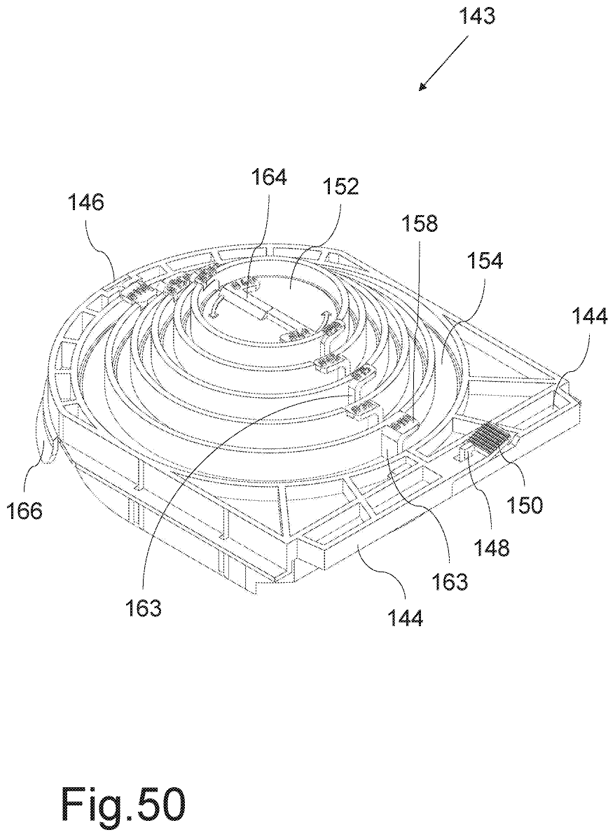

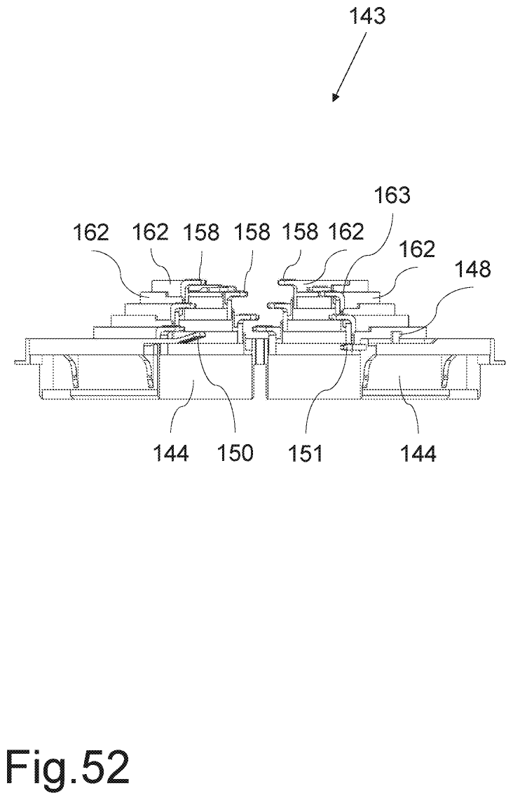

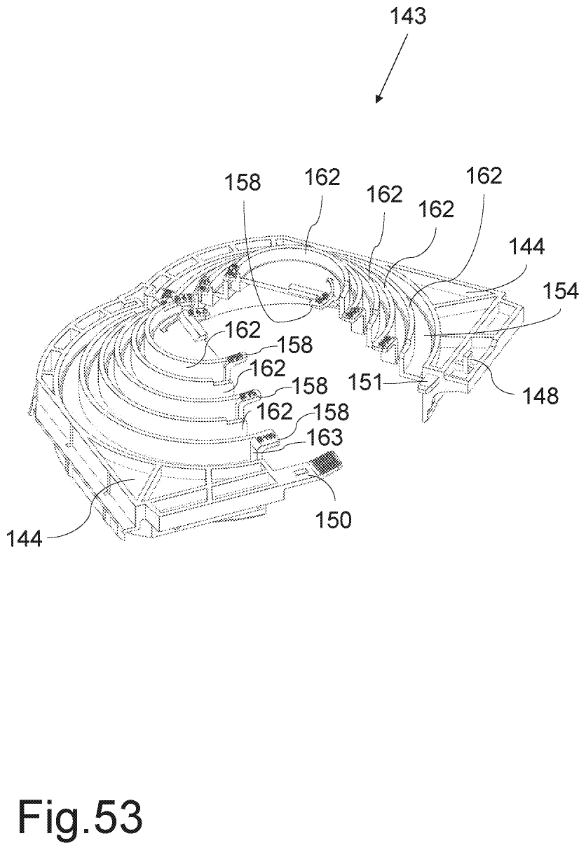

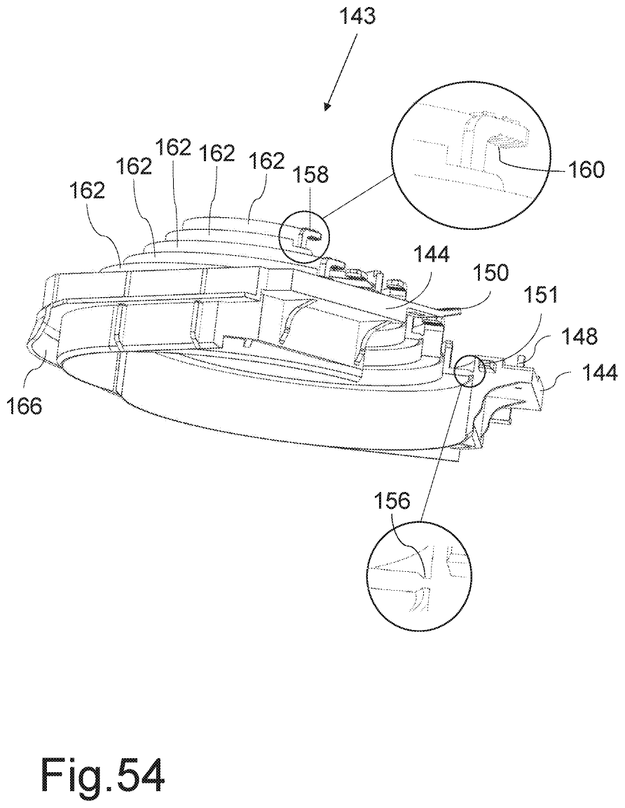

FIG. 4 shows two adapter plugs 143 attached to a side wall 16. FIGS. 47 to 54 show the adapter plug 143 in detail.

The adapter plug 143 consists of two halves 144 which can be brought into a closed state starting from an assembly position. A semicircular opening is formed in each half 144, the dimensions of which are adapted to the outer diameter of the line to be passed through and which together form a circular opening when the two halves 144 are fastened in the closed state.

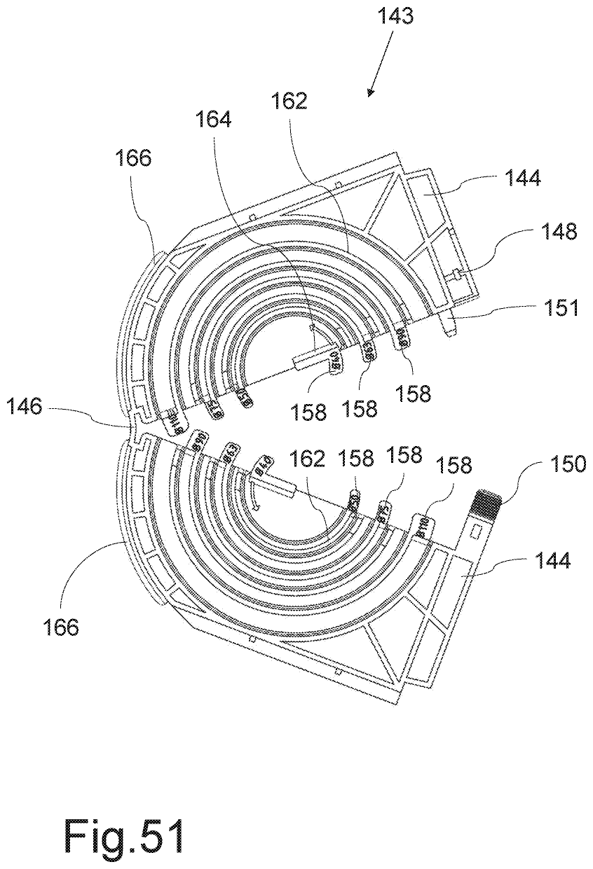

FIGS. 51 to 54 show the adapter plug 143 in a state in which it can be removed from an injection mold and which corresponds to the assembly state in which the two halves can be placed on a line. The two halves 144 are connected to each other by means of a film hinge 146 arranged on an outer edge.

On the side opposite the film hinge 146, a closing hook 148 is provided on one half 144 and a closing tab 150 is provided on the other half 144, by means of which the two halves 144 can be fastened to each other at their end facing away from the film hinge. This places the adapter plug 143 in the closed state shown in FIGS. 47 to 50, in which the two halves 144 rest against each other along a parting line. A centering punch 151 ensures that the halves 144 are positioned precisely.

In the position of use, a central circle 152 and a plurality of ring sections 154 which are connected to each other by predetermined breaking point-like tear-off lines 156 are delimited from each other in the adapter plug 143. By removing the circle 152 and possibly also one or more ring sections 154, an opening having a desired diameter can be created.

In the example embodiment shown, the circle 152 has a diameter of 40 mm. The ring sections 154 correspond to openings having diameters of 50 mm, 63 mm, 75 mm, 90 mm, and 110 mm.

The ring sections 154 are here arranged concentrically with respect to the central circle 152.

Each half 144 of the adapter plug 143 is provided with tear-off tabs 158, by means of which the respective section can be separated from the rest of the adapter plug 143 without the need for tools. If, for example, an opening having a diameter of 63 mm is to be obtained, a semicircle is delimited on each half 144 using the tear-off tab 158, labeled 63, which consists of the inner semicircle for the opening having a diameter of 40 mm, a half ring for the opening having a diameter of 50 mm, and a half ring for the opening having a diameter of 63 mm.

To make the tear-off tab 158 easier to grip, it is provided with ribs 160 on its unmarked underside.

Each ring section 154 is provided with an annular reinforcement 162 on its radially inner side. The tear-off line 156 is provided on the radially outer side of each ring section 154, which the annular reinforcement 162 of the next ring section 154 adjoins radially on the outside.

On the one hand, the tear-off tabs 158 of the ring sections 154 are attached to the annular reinforcement 162. On the other hand, the tear-off tabs 158 are connected directly to the ring section 154 by an extension 163, so that upon tearing, the tensile forces act directly next to the tear-off line 156 and facilitate the separation of the ring section 154 from the outer ring section 154 remaining on the adapter plug 143.

The tear-off tabs 158 of the semicircles 152 are attached to a solid block 164 which extends from the center outwards up to the tear-off line 156.

As can be seen in FIG. 51, each tear-off tab 158 protrudes from the half 144 of the adapter plug 143 to which it is attached, so that when the adapter plug 143 is closed, it protrudes beyond the parting plane. This makes the tear-off tabs 158 easy to grip.

To increase the distance between the tear-off tabs 158 of adjacent “sizes” and make it easier for an installer to grip the respective tear-off tab 158, the tear-off tabs 158 are arranged alternately. Taking the upper half 144 in FIG. 51 as an example, the tear-off tab 158 for the 40 mm opening is located on the right side, the tear-off tab 158 for the 50 mm opening is located on the left side, the tear-off tab 158 for the 63 mm opening is again on the right side, etc.

On the side of the film hinge 146, the adapter plug 143 is provided with two clamping lips 166 (see in particular FIGS. 47, 48, and 49). These are elastically resilient and serve to brace the adapter plug 143 at a side wall 16 of the manhole 10 when it is mounted there, so that it remains in its position until it is pressed against the outside of the manhole 10 after the pit has been filled with soil.

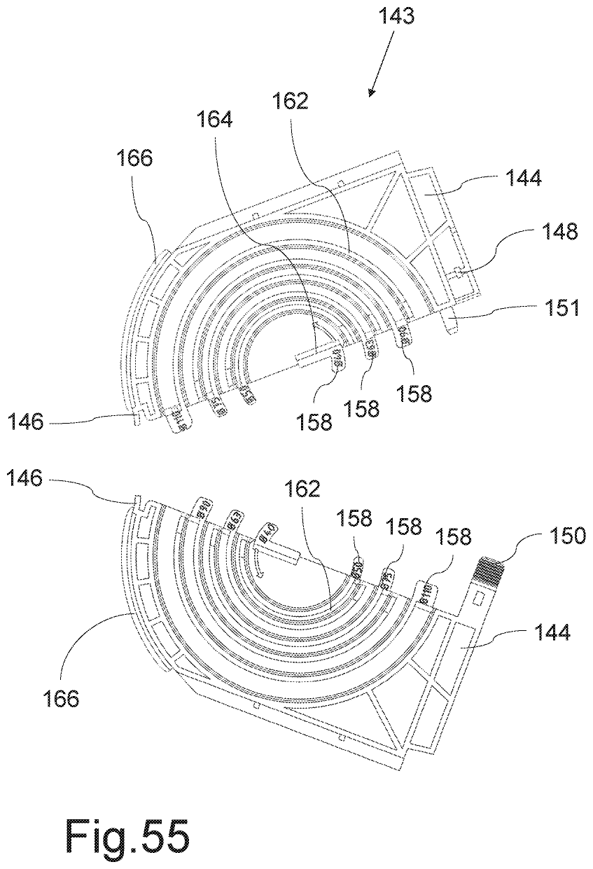

FIG. 55 shows a variant embodiment. The same reference numerals are used for the components and features known from the first embodiment, reference being made to the above explanations in this respect.

The difference between the embodiment of FIGS. 47 to 54 and the variant embodiment of FIG. 55 is that in the variant embodiment, no film hinge is used, but the two halves are manufactured as separate parts. When attaching the adapter plug 143 to a line, the two halves 144 are fastened to each other at one end using a plug-in or latching connection (i.e., at the end where the film hinge is provided in the previous embodiment), and at the other end, the two halves are fastened to each other in the closed state by the closing hook 148 and the closing tab 150.

While the disclosure has been described with reference to a preferred embodiment, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A wall element for a side wall of a manhole, comprising:
complementary components of module latching parts being arranged at opposite edges.

2. The wall element of claim 1, wherein the module latching parts are formed by at least one plug-in nose on one edge of the wall element and at least one plug-in receptacle on the opposite edge.

3. The wall element of claim 2, wherein the plug-in nose has a thickness decreasing towards the free end.

4. The wall element of claim 2, wherein the plug-in nose has a curved outer surface.

5. The wall element of claim 2, wherein a snap-in element is provided in the plug-in receptacle, which can cooperate with an abutment on the plug-in nose of a second wall element.

6. The wall element of claim 5, wherein an engagement recess is provided on the plug-in receptacle and on the plug-in nose so that the snap-in element can be moved by hand from a locking position to a release position.

7. The wall element of claim 6, wherein the module latching parts have at least two connecting blocks at a first end in a first and a third position and at least two connecting blocks at a second end in a second and a fourth position, wherein at least two receiving openings are provided at the first end at a second and a fourth position and at least two receiving openings are provided at the second end at a first and a third position.

8. The wall element of claim 7, wherein at least one snap-in element is provided at each end, which can cooperate with an abutment at the associated end of another wall element.

9. The wall element of claim 8, wherein the abutment has a groove which can serve as a guide for an unlocking tool.

10. The wall element of claim 9, wherein two snap-in elements are provided.

11. The wall element of claim 7, wherein an insertion bevel is provided on the connecting blocks and/or the receiving openings.

12. The wall element of claim 11, wherein a guiding projection is provided, of which the insertion bevel cooperates when the corners are connected to each other, wherein the insertion bevel is located outside the guiding projection in the fully assembled state.

13. A module for a manhole, wherein the module is composed of four interconnected wall elements according to claim 1, the fourth of which is adapted to be connected to two other wall elements by a combined plugging and rotary movement to form a closed module.

14. The module of claim 13, wherein the wall elements can be detached from each other without tools.

15. The module for a manhole, wherein the module is composed of four interconnected wall elements according to claim 1, the fourth of which is adapted to be connected to two other wall elements by a purely translational movement to form a closed module.

16. The module of claim 15, wherein the wall elements are adapted to be detached from each other by a plug-in tool.
